(19) United States
(12) Patent Application Publication
(10) Pub. No.: US 2002/0090871 A1
(43) Pub. Date: Jul. 11, 2002

(54) Cementitious panel with basalt fiber reinforced major surface(s)

(76) Inventors: Charles Stokes Ritchie, Charlotte, NC (US); Edward A. Burkard, East Amherst, NY (US)

Correspondence Address: Christopher J. Buntel, Ph.D., Howrey Simon Arnold & White, LLP, 750 Bering Drive, Houston, TX, 77057-2198, US

(21) Appl. No.: 09/978,868

(22) Filed: Oct. 16, 2001

Related U.S. Application Data
(60) Provisional application No. 60/241,072, filed on Oct. 17, 2000.

(51) Int. Cl. B32B 13/02

(52) U.S. Cl. 442/42; 442/21; 442/25; 442/26; 442/57

(57) ABSTRACT

A cementitious panel having a basalt fiber-containing reinforcing web embedded in at least one major surface, preferably both major surfaces, of the panel. The basalt fibers-containing reinforcing webs preferably are in the form of a mesh or scrim comprising spaced basalt fiber strands in both the warp and fill directions, each strand made from a plurality of aligned, continuous basalt fibers. The basalt fiber reinforcing webs also can be in the form of woven or non-woven fabrics of basalt fibers, having aligned or randomly oriented staple and/or micro fibers, so long as the fabrics have sufficient void area to permit a cementitious core material to penetrate the fabric when the fabric is embedded in one or both major surfaces of the cementitious panel before the cementitious core material hardens.

### CROSS REFERENCE TO RELATED APPLICATIONS

The present application is related to U.S. Provisional Patent Application Ser. No. 60/241,072 filed Oct. 17, 2000.

### FIELD OF THE INVENTION

The present invention relates to reinforced cementitious panels or boards comprising a cementitious core, the boards or panels being basalt fiber-reinforced at one or both major surfaces. More particularly, the present invention relates to panels or boards having opposed major surfaces reinforced by a network of basalt fibers adhered to and embedded within the major surface(s) thereof, e.g., adhered to or embedded at or just below the cementitious upper and lower, opposed major surfaces thereof. Such a cementitious panel or board may, for example, be a concrete panel, a tile backer board panel, a gypsum panel, a gypsum cement panel, or the like.

### BACKGROUND OF THE INVENTION

In general, a reinforced cementitious panel or board may be fastened to a wall frame for the construction of a wall, and particularly for the construction of a wall where high moisture conditions are to be encountered. Such a wall panel may provide a long lasting substrate for humid or wet areas, such as shower rooms and bath rooms, and provide high impact resistance. For example, such a reinforced cementitious panel or board may be used as a substrate for ceramic tile in bath rooms, shower rooms, locker rooms, swimming pool rooms and other areas where the walls are subjected to frequent splashing of water or high humidity. Once the panel is affixed to a wall frame, a wall facing material may be affixed thereto such as, for example, ceramic tile, thin brick, thin marble panels, stucco, or the like.

Reinforced cementitious panels or boards having cores formed of a cementitious composition with the major faces being reinforced with a layer of glass fiber web bonded thereto are known; see for example, U.S. Pat. Nos. 1,439,954; 3,284,980; 4,450,022, and 4,916,604.

Various processes for the preparation of such cementitious boards or panels are also known. British patent application No. 2,053,779, for example, discloses a method for the continuous production of a building board which comprises advancing a pervious glass fabric on a lower support surface, depositing a slurry of cementitious material onto the advancing glass fabric, and then contacting the exposed face of the slurry with a second glass fabric such that the slurry penetrates through the fabric to form a thin, continuous film on the outer faces of the glass fabric.

Basalt is an igneous mineral ore that can be melted and formed into continuous fibers, staple fibers, e.g., 30 mm in length, micro fibers of, for example, 0.42 μm in diameter, and intermediate lengths and diameters. Basalt fibers have been (a) used to make papermaking fabric, see U.S. Pat. No. 5,925,221; (b) zirconia coated for alkali resistance, see J. Mater. Res., Vol. 9, No. 4, p. 1006 (1966); (c) used for internally reinforcing cement in concrete, see U.S. Pat. No. 4,304,604; to reinforce thermosetting resins, particularly epoxy resins and polyester resins, see Popular Plastics, February, 1982, pages 6-8; and (d) formed from a melt of both glass and basalt rock, UK published application 2,019,386 A (1979).

Because of its cementitious nature, a cement board may have a tendency to be relatively brittle at its edges, where it is often attached to a building framework with fasteners such as nails, screws and the like. When fasteners such as screws or nails are installed near the edge, it is highly desirable that the edge be able to retain sufficient structural integrity such that the panel remains attached to a wall member, i.e., that the panel have a relatively high fastener pull resistance such that the fastener will not laterally pull through or break through the board edge.

It is known to augment the strength of the border edge regions by wrapping a glass fabric, covering one of the major surfaces of the board, around the edge so as to overlay the glass fabric on the other opposite major surface thereof U.S. Pat. No. 4,916,004 discloses a cement board having a woven mesh of glass fibers immediately below each major surface thereof, the mesh in one major surface continuing under the surface of both longitudinal edge faces, with the two meshes in an abutting or an overlapping relation along the longitudinal margins of the opposite face. Additional patents disclosing edge reinforcement include U.S. Pat. Nos. 5,221,386 and 5,350,554. U.S. Pat. No. 4,504,533 discloses a gypsum board in which a composite web of a non-woven fiberglass felt and a woven fiberglass mat covers the upper and lower faces of a gypsum core while only the lower non-woven fiberglass felt is wrapped around the longitudinal edges of the gypsum core so that the non-woven fiberglass felt extends partially inward on the upper face of the core such that the border edge regions are covered only by non-woven fiberglass felt.

U.S. Pat. No. 1,787,163 discloses a gypsum board in which side edge portions include a separate strip of U-shaped fabric extending from one major surface across the edge to the other major surface; the fabric legs of this separate strip each extend into the plaster core body beneath a respective sheet of fibrous material covering a respective board face, i.e., the legs are submerged below the broad face and in particular below the major surface reinforcement glass fabric.

There exists a need for improved board materials that are easily produced, and display improved physical properties as compared to conventionally prepared materials.

### SUMMARY OF THE INVENTION

In brief, the present invention is directed to a cementitious panel having a basalt fiber-containing reinforcing web embedded in at least one major surface, preferably both major surfaces, of the panel. The basalt fibers-containing reinforcing webs preferably are in the form of a mesh or scrim comprising spaced warp and woof strands, each strand made from a plurality of aligned, continuous basalt fibers. The basalt fiber reinforcing webs also can be in the form of woven or non-woven fabrics of basalt fibers, having aligned or randomly oriented staple and/or micro fibers, so long as the fabrics have sufficient void area to permit a cementitious core material to penetrate the fabric when the fabric is embedded in one or both major surfaces of the cementitious panel before the cementitious core material hardens.

Cementitious panels containing basalt fiber reinforcing webs are unexpectedly easily manufactured, particularly since basalt fiber reinforcing webs can be manufactured to be more easily embedded in a relatively viscous cementitious core material; and the panels have one or more of the following properties unexpectedly improved by virtue of one or more basalt fiber reinforcing members embedded in one or both major surfaces: tensile strength; cohesive strength; impact strength; temperature resistance; rigidity; strength uniformity; structural stability; flexural strength; resistance to water penetration and moisture degradation; uniformity of dimensions; reduced cockle; alkali resistance; surface density; surface smoothness; lower cost; nailability without cracking, breaking or other failure; and can be manufactured using existing wallboard or cement backer board manufacturing production lines.

Accordingly, one aspect of the present invention is to provide a cementitious panel containing a basalt fiber reinforcing web embedded in one or both major surfaces, preferably both major surfaces.

Another aspect of the present invention is to provide a cementitious panel that is unexpectedly enhanced in one or more of the following properties by virtue of containing basalt fiber reinforcing webs embedded in its major surfaces instead of a glass reinforcing web: ease of manufacture; ease of reinforcing web embedding; tensile strength; cohesive strength; impact strength; temperature resistance; rigidity; strength uniformity; structural stability; flexural strength; resistance to water penetration and moisture degradation; uniformity of dimensions; reduced cockle; alkali resistance; surface density; surface smoothness; resistance to panel cracking; nailability without cracking, breaking or other failure.

The cementitious boards of the present invention optionally also include edge reinforcement.

Still another aspect of the present invention is to provide a panel containing a basalt fiber water-laid mat that reinforces one or both major surfaces of a cementitious core material comprising cement, gypsum or a combination of cement and gypsum.

The above and other aspects and advantages of the present invention will become more apparent from the following detailed description of the preferred embodiments, taken in conjunction with the drawings.

### DESCRIPTION OF THE FIGURES

The following figures form part of the present specification and are included to further demonstrate certain aspects of the present invention. The invention may be better understood by reference to one or more of these drawings in combination with the detailed description of specific embodiments presented herein.

FIGS. 1 to 4 illustrate in schematic cross-sectional views steps in the formation of a cementitious, basalt fiber-reinforced example panel in accordance with the present invention;

FIG. 5 is a schematic partial cross-sectional view of a reinforced edge of a panel made in accordance with the steps illustrated in FIGS. 1 to 4;

FIG. 6 is a schematic partial cross-sectional view of a reinforced edge of another example panel made in accordance with the present invention wherein only one major surface includes a reinforcing mesh at the marginal edge area thereof;

FIGS. 7 to 11 illustrate in schematic cross-sectional views steps in the formation is of another example panel in accordance with the present invention having a U-shaped edge reinforcing mesh;

FIG. 12 is a schematic partial cross-sectional view of a reinforced edge of a panel made in accordance with the steps illustrated in FIGS. 7 to 11;

FIGS. 13 and 13a each illustrate in schematic partial cross-sectional view a step in the formation of additional example panels in accordance with the present invention wherein the bridging member is not adhered to the core;

FIGS. 14 and 14a are each schematic partial cross-sectional views of a reinforced edge of a panel made in accordance with a process respectively including the step illustrated in FIGS. 14 and 14a;

FIG. 15 is a schematic partial cross-sectional view of the edge of another example panel in accordance with the present invention;

FIG. 16 is a schematic partial cross-sectional view of the edge of a further example panel in accordance with the present invention;

FIG. 17 is a schematic partial cross-sectional view of the edge of yet another example panel in accordance with the present invention;

FIG. 18 is a partial schematic perspective view of the forward end of an apparatus in accordance with the present invention for making an edge reinforced panel in accordance with the present invention;

FIG. 19 is a partial schematic perspective view of the central part of the example apparatus for which the forward end is shown in FIG. 18;

FIG. 19a is a schematic enlarged side view of the crank system for a support member of the first mesh layer alignment component shown in FIG. 19 and which includes dual crank components;

FIG. 19b is a schematic enlarged top view of the crank system shown in FIG. 19a;

FIG. 19c is a schematic enlarged end view of the crank system shown in FIG. 19a;

FIG. 20 is a partial schematic perspective view of the rear end of the example apparatus for which the forward end is shown in FIG. 18;

FIG. 21 is a partial schematic perspective view of the forward end of an apparatus in accordance with the present invention for making an edge reinforced panel in accordance with the present invention wherein the bridging member is not adhered to the core;

FIG. 22 is a partial schematic perspective view of an example strip feeding mechanism for feeding reinforcing strips to the forward end illustrated in FIG. 18;

FIG. 23 is a partially broken-away perspective view of one embodiment of the basalt fiber-reinforced panel of the present invention comprising a gypsum cement core material having upper and lower major surfaces reinforced with basalt fiber scrims, and including edge reinforcement;

FIG. 23a is a partially broken-away perspective view of a basalt fiber-reinforced panel of the present invention comprising a gypsum core material having upper and lower major surfaces reinforced with basalt fiber scrims;

FIG. 24 is a partially broken away view of a basalt fiber scrim used to reinforce the upper and/or lower major surfaces of a cementitious core material;

FIG. 25 is a partial broken away view of a basalt fiber non-woven fabric used to reinforce the upper and/or lower major surfaces of a cementitious core material; and

FIG. 26 is a partially broken away view of a basalt fiber woven fabric used to reinforce the upper and/or lower major surfaces of a cementitious core material.

### DEFINITIONS

The following definitions are provided in order to aid those skilled in the art in understanding the detailed description of the present invention.

The word “cementitious” as used herein is to be understood as referring to any material, substance or composition containing or derived from a hydraulic cement such as, for example, portland cement and/or gypsum (calcium hemihydrate). The term “slurry” is to be understood as referring to a flowable mixture, e.g., a flowable mixture of water and a hydraulic cement. The term “core” is to be understood as referring to a mixture of a hydraulic cement and water with or without an aggregate (such as sand, expanded shale or clay, expanded polystyrene beads, slag and similar materials—see below), as well as, optionally, additional additives such as foaming agents, modifiers and the like.

The term “slurry-pervious reinforcing mesh” is to be understood as characterizing a basalt fiber-containing mesh that is suitable for use in the preparation of a cementitious panel, particularly having a cement or gypsum cement core, by having openings in the mesh that are sufficiently large to permit penetration of a cementitious slurry or a slurry component of a core mix into and through the openings so as to permit mechanical bonding of the mesh to the core either by, for example, being cemented to the core or by being embedded in a face or surface of the core of a panel.

It is to be understood herein that the expression “adhered to” in relation to a basalt fiber reinforcing component (e.g., mesh, mat, fabric, tissue, scrim, and the like) means that the reinforcing component may be adhered to a major surface and/or side surface by any suitable means such as by an adhesive, by a cement, or by being embedded in, at or immediately beneath the surface of a respective major surface and/or side surface such that the reinforcing component is effectively bonded to the core, i.e., a hardened or set cementitious material extends through the interstices of the basalt fiber layer(s).

The expression “adhered to the core at” in relation to a basalt fiber reinforcing component (e.g., mesh, mat, fabric, tissue, scrim, and the like) means that the reinforcing component does not extend beyond the specified face, area, region, or the like, i.e., it is restricted to the specified face region. Thus, for example, in relation to a major surface, basalt fiber reinforcing mesh indicated as being adhered to a core at a major surface means that the mesh is restricted to being adhered to the major surface.

The word “woven” as used herein is to be understood as characterizing a material such as a reinforcing component (e.g., mesh, mat, fabric, tissue, scrim, or the like), as comprising fibers or filaments which are oriented; oriented fibers or filaments being disposed in an organized fashion.

The word “non-woven” as used herein is to be understood as characterizing a material such as a reinforcing component (e.g., mesh, mat, fabric, tissue, scrim, or the like), as comprising fibers or filaments which are oriented (as described above) or which are non-oriented; non-oriented fibers or filaments being disposed in random fashion.

### DETAILED DESCRIPTION OF THE INVENTION

Core Materials

The cementitious core material can be gypsum, concrete, cement and/or gypsum cement, with or without aggregate.

Gypsum Core Compositions

A conventional process for manufacturing a core composition for gypsum wallboard (e.g., see T. Michelsen, “Building Materials (Survey),” Encyclopedia of Chemical Technology, (1992 4th ed.), vol. 21, pp. 621-24, the disclosure of which is hereby incorporated herein by reference) initially includes the premixing of dry ingredients in a high-speed mixing apparatus. The dry ingredients can include calcium sulfate hemihydrate, an accelerator, and a binder (e.g., starch). The dry ingredients are mixed together with a “wet” (aqueous) portion of the core composition in a pin mixer apparatus. The wet portion can include a first component, commonly referred to as a “paper pulp solution,” that includes a mixture of water, paper pulp, and, optionally, one or more fluidity-increasing agents, and a set retarder. The paper pulp solution provides a major portion of the water that forms the gypsum slurry of the core composition. A second wet component can include a mixture of foam and other conventional additives, if desired. Together, the aforementioned dry and wet portions comprise an aqueous gypsum slurry that forms a wallboard core composition.

A major ingredient of the gypsum wallboard core composition is calcium sulfate hemihydrate, commonly referred to as “calcined gypsum,” “stucco,” or “plaster of Paris.” Stucco has a number of desirable physical properties including, but not limited to, its fire resistance, thermal and hydrometric dimensional stability, compressive strength, and neutral pH. Typically, stucco is prepared by drying, grinding, and calcining natural gypsum rock (i.e., calcium sulfate dihydrate). The drying step of stucco manufacture includes passing crude gypsum rock through a rotary kiln to remove any free moisture present in the rock from rain or snow, for example. The dried rock then is passed through a roller mill (or impact mill types of pulverizers), wherein the rock is ground or comminuted to a desired fineness. The degree of comminution is determined by the ultimate use. The dried, fine-ground gypsum can be referred to as “land plaster” regardless of its intended use. The land plaster is used as feed to calcination processes for conversion to stucco.

The calcination (or dehydration) step in the manufacture of stucco is performed by heating the land plaster, and generally can be described by the following chemical equation which shows that heating calcium sulfate dihydrate yields calcium sulfate hemihydrate (stucco) and water vapor:

CaSO₄.2 H₂O+heat→CaSO₄.½ H₂O+1½ H₂O.

This calcination process step is performed in a “calciner,” of which there are several types known by those of skill in the art.

Uncalcined calcium sulfate (i.e., land plaster) is the “stable” form of gypsum. However, calcined gypsum, or stucco, has the desirable property of being chemically reactive with water, and will “set” rather quickly when the two are mixed together. This setting reaction is actually a reversal of the above-described chemical reaction performed during the calcination step. The setting reaction proceeds according to the following chemical equation which shows that the calcium sulfate hemihydrate is rehydrated to its dihydrate state:

CaSO₄.½H₂O+½ H₂O→CaSO₄.2H₂O+heat.

The actual time required to complete the setting reaction generally depends upon the type of calciner and the type of gypsum rock that are used to produce the gypsum, and can be controlled within certain limits by the use of additives such as retarders, set accelerators, and/or stabilizers, for example. Generally, the rehydration time period can be in a range of about two minutes to about eight hours depending on the amount and quality of retarders, set accelerators, and/or stabilizers present.

After the aqueous gypsum slurry is prepared, the slurry and other desired ingredients are combined to form a core composition that is continuously deposited to form a wallboard core between two continuously-supplied moving sheets of board cover paper. In accordance with the present invention, the cover paper is substituted with a basalt fiber-containing mesh, scrim or fabric, on one or both major surfaces. As the core composition is deposited onto the basalt fiber reinforcing components, the backing basalt fiber reinforcing component is brought down atop and embedded within the deposited core composition. The whole assembly then is sized for thickness utilizing a roller bar or forming plate. The deposited core composition is then allowed to set between the two basalt fiber-containing cover sheets, thereby forming a basalt fiber-reinforced gypsum wallboard in accordance with the present invention. The continuously-produced board is cut into panels of a desired length and then passed through a drying kiln where excess water is removed to form a strong, dry, and rigid building material.

Standardized sheets (or panels) of wallboard typically are cut and trimmed to dimensions of about four feet (about 1.2 meters) wide and about 8 feet to about 16 feet (about 2.4 meters to about 4.9 meters) in length (ASTM-C36). Sheets typically are available in thicknesses varying in a range of about ¼ inch to about one inch (about 0.635 centimeters (cm) to about 2.54 cm) in about ⅛ inch (about 0.3175 cm) increments. Standardized sheets of wallboard typically have a density in a range of about 1,600 pounds (lbs) to about 1,700 lbs per thousand square feet (lbs/MSF) (about 7,800 kilograms (kg) to about 8,300 kg per thousand square meters (m²)) of about one-half inch (1.27 cm) board.

The time at which the board may be cut, or in other words, the speed of the conveyor and the consequent rate of production of the gypsum board, is generally controlled by the setting time of the calcined gypsum slurry. Thus, conventional adjuvants to the calcined gypsum slurry in the mixer generally include set time control agents, particularly accelerators. These and other additives, such as pregenerated foam to control final density of the board, paper cover sheet bond promoting agents, fibrous reinforcements, consistency reducers and the like typically constitute less than 5%, and usually less than 2%, of the weight of the finished board core.

Walls and ceilings made with gypsum wallboard panels typically are constructed by securing, e.g., with nails or screws, the wallboard panels to structural members, such as vertically- and horizontally-oriented pieces of steel or wood often referred to as “studs.” To provide satisfactory strength, commercially-available gypsum wallboard generally requires a density of about 1,600 lbs/MSF to about 1,700 lbs/MSF (about 7,800 kg per 1,000 m2 to about 8,300 kg per 1,000 m²) of about one-half inch (1.27 cm) board.

The gypsum core compositions of a preferred wallboard core composition of the invention will now be described in more detail. One dry ingredient present in the wallboard core composition of the invention is calcium sulfate hemihydrate, or stucco (CaSO₄.½H₂O). Preferably, the P-hemihydrate form of calcium sulfate hemihydrate is used in the invention, however, either the α- or β-form may be used. The core composition includes at least about 30 wt. % calcium sulfate hemihydrate, preferably about 30 wt. % to about 70 wt. %, more preferably about 35 wt. % to about 55 wt. %, and even more preferably about 40 wt. % to about 55 wt. %, for example about 48 wt. % calcium sulfate hemihydrate based on the total weight of the core composition. The calcium sulfate hemihydrate can be produced by a dry calcination method, such as kettle, calcidyne, holoflyte, rotary kiln, impmill, or caludis peter calcination.

Other dry ingredients may be included in the core composition, including an accelerator, which can be used to control the crystal growth rate and set time of the stucco. Examples of suitable accelerators, some of which also are available liquid form, include, but are not limited to, ball mill accelerators (“BMA”) and metallic salts that provide cations, such as aluminum sulfate, potassium sulfate, calcium sulfate, ferrous sulfate, and ferric chloride supplied, for example, by the J.T. Baker Chemical Company of Philadelphia, N.J.

Wet ingredients used to make the core composition preferably include an aqueous slurry or solution of pulp including water and paper fibers (“paper pulp”), and may also include corn starch and/or potash. The paper pulp solution provides a major portion of the water that forms the gypsum slurry of the core composition. The water supplied in the wet portion of the composition should include sufficient water for the setting reaction of the gypsum, plus an additional amount sufficient to decrease the consistency of the slurry during the manufacturing process.

The paper fibers in the pulp solution serve to enhance the flexibility of the gypsum wallboard. Gypsum wallboard made without fibers is typically very brittle and more susceptible to breakage during handling. The paper fibers aid in evenness of drying during manufacture, and enhance the ability of the final wallboard product to accept and hold nails during installation.

A set retarder optionally may be included in the paper pulp solution and can be used in conjunction with the aforementioned accelerator in order to tailor the set time of the core composition. Retarding agents are typically used in the invention at very low concentrations such as, for example, about 0.0007 wt. %, based on the weight of the core composition.

The pulp solution can be prepared by blending or mixing the above ingredients with water in a blending apparatus. Alternatively, a concentrated pulp solution using only a small volume of water can be produced. In this case, the remainder of the core mix water requirement is made up with a separate water source. Typically, about 75 weight parts water are used per 100 weight parts stucco. Preferably, high shear mixing “pulps” the material, forming a homogenous solution or slurry. The pulp solution can be transferred to a holding vessel, from which it can be continuously added to the core composition mix.

Wet ingredients used to make the core composition preferably include a component that incorporates a foaming agent. Foam introduces air voids into the core through the use of a foaming agent that contains very little solid material, but is resilient enough to resist substantial breakdown in the mixing operation. In this manner, the density of the core can be controlled. Known foaming agents may be supplied in either liquid or flake (powdered) form, and may be produced from soaps known in the art. A suitable foaming agent for the invention is sold under the trade name CEDEPAL FA-406, by the Stepan Company of Northfield, Ill.

An antidessicant such as starch also can be included in the core composition to prevent the dehydration of calcium sulfate dihydrate crystals formed during setting of the core composition. A suitable starch for the invention is Wallboard Binder Starch, CAS #65996-63-6, which is sold by A.E. Staley Manufacturing Co., of Decatur, Ill. In some products, lightweight aggregates (e.g., expanded perlite or vermiculite) also can be included.

“Water-reducing” additives may be included in the core composition to improve its fluidity while allowing the use of reduced levels of water. Reduction in water usage brings reduced costs in the form of reduced water and energy demands, as less water will have to be removed during the drying step(s). Reduction of water usage also provides environmental benefits.

Various commercially-available fluidity-enhancing and/or water-reducing agents are known in the art for various applications. Materials used as fluidity-enhancing and/or water-reducing agents include “lignosulfonates” which are commercially available either in liquid or powder form. Fluidity-enhancing and/or water-reducing agents supplied in liquid form can be either incorporated in the pulp solution or added directly to the mixing operation. A suitable water-reducing agent for the invention is sold under the trade name DILOFLO GW, by the Henkel Corporation of Ambler, Pa. The use of condensation products of naphthalene sulfonic acid and formaldehyde is also known. See also U.S. Pat. No. 4,184,887, the disclosure of which is hereby incorporated herein by reference.

Water-reducing agents are described in “The Gypsum Industry and Flue Gas Desulfurization (FGD) Gypsum Utilization: A Utility Guide,” New York State Electric & Gas Corp. and ORTECH, pp. 3-38 (1994), the disclosure of which is hereby incorporated herein by reference.

The use of higher molecular weight anionic condensation products such as melamine formaldehyde modified with sulfite alkylaryl sulfonates and lignin sulfonates, preferably calcium lignosulfonate, ammonium lignosulfonate, sodium lignosulfonate, and naphthalene sulfonate is also known.

Gypsum wallboard can be adapted for wet and exterior applications, in addition to use in constructing interior walls and ceilings. In the production of exterior sheathing and moisture-resistant board cores, various materials can be incorporated into the core composition to impart increased absorption resistance to the board. Useful materials include silicone and other water repellents, waxes, and asphalt emulsions. These materials are typically supplied as water emulsions to facilitate ease of incorporation into the board core. These materials can be added directly into the mixing apparatus or incorporated into the pulp solution prior to addition to the mixing apparatus.

The invention is not limited to any order or manner of mixing the ingredients described above.

General ranges of slurry ingredients used in gypsum wallboard are shown in Table 1 below, wherein the wt. % of an ingredient is based on the total weight of the core composition used to make the wallboard product, unless otherwise indicated.

TABLE 1
(Gypsum Slurry)

| Ingredient | Exemplary Range | | |
|---|---|---|---|
| stucco | about | 48 | wt.% to |
| | about | 55 | wt. % |
| accelerator | about | 0.04 | wt. % to |
| | about | 0.25 | wt. % |
| antidessicant, e.g., starch | about | 0.12 | wt. % to |
| | about | 0.32 | wt. % |
| retarder | about | 0 | to |
| | about | 0.2 | wt. % |
| fibrous flexibility enhancer, e.g., | about | 0.06 | wt. % to |
| paper pulp | about | 0.33 | wt. % |
| pulp water | about | 36 | wt. % to |
| | about | 44 | wt. % |
| foam solution (including water) | about | 4 | wt. % to |
| | about | 12 | wt. % |

A preferred process for manufacturing the core composition and basalt fiber-reinforced wallboard of the invention initially includes the premixing of dry ingredients in a mixing apparatus. The dry ingredients preferably include calcium sulfate hemihydrate (stucco), an optional accelerator, and an antidessicant (e.g., starch), as described below in greater detail. The dry ingredients are preferably mixed together with one or more “wet” (aqueous) portions of the core composition in a pin mixer apparatus.

The core composition thus produced is deposited between basalt fiber meshes, scrims or fabric sheets to form a sandwich. The core composition is allowed to cure or set, whereby calcium sulfate hemihydrate is converted to calcium sulfate dihydrate. The product then preferably is dried by exposing the product to heat, in order to remove excess water not consumed in the reaction forming the calcium sulfate dehydrate.

The setting reaction produces gypsum crystals, which are interwoven to contribute strength to the dried wallboard core. The strength of the crystal-to-crystal interaction contributes to the final strength of the gypsum wallboard product. The gypsum crystals also unexpectedly provide a superior bond with basalt fiber reinforcing webs embedded in the major surfaces of the gypsum core composition. This bonding or interaction also increases the strength of the wallboard product.

After setting, the above gypsum slurry provides the following core composition for the gypsum panel:

TABLE 2

| Ingredient | Typical Range % |
|---|---|
| Gypsum | 94-99.5 |
| Starch | 0.3-0.6 |
| Pulp | 0.1-0.4 |
| Accelerator | 0.1-0.6 |
| Retarder | 0.06-0.12 |
| Foaming Agent | 0.01-0.06 |

Gypsum Cement Core Compositions:

A master blend gypsum cement core material preferably includes about 20 wt. % to about 75 wt. % calcium sulfate beta-hemihydrate (i.e., beta-gypsum), about 10 wt. % to about 60 wt. % portland cement (Type III is preferred), and about 4 wt. % to about 20 wt. % silica fume. The ratio of silica fume to portland cement should be at least about 0.3/1.0 when the binder is produced by dry-blending the gypsum, portland cement and silica fume. If the silica fume is dispersed in water, followed by mixing with dry-blended gypsum and portland cement, the ratio of silica fume to portland cement should be at least about 0.2/1.0. Aggregate and/or fiber may be added to the master blend binder to form a construction material.

Preferred core materials according to the invention may be categorized by application. For interior applications, such as fiberboard, for use in relatively dry areas, Core Material I set forth in Table 3, is preferred.

TABLE 3
CORE MATERIAL I (interior)

Process

| | | Silica Fume |
|---|---|---|
| Core Components¹ | Dry Blend² | Pre-Dispersed³ |
| Stucco | 60-75 | 60-75 |
| Portland Cement | 20-31 | 21-33 |
| Silica Fume | 6-9 | 4-7 |

¹All amounts in percent by weight.
²Silica fume/portland cement ratio of at least about 0.3/1.0.
³Silica fume/portland cement ratio of at least about 0.2/1.0.

For interior applications, such as shower backer boards, for use in relatively wet areas, Core Material II, set forth in Table 4, is preferred.

TABLE 4
CORE MATERIAL II (Interior/Wet Areas)

Process

| | | Silica Fume |
|---|---|---|
| Core Components¹ | Dry Blend² | Pre-Dispersed³ |
| Stucco | 50-60 | 50-60 |
| Portland Cement | 31-37 | 33-42 |
| Silica Fume | 9-11 | 7-8 |

¹All amounts in percent by weight.
²Silica fume/portland cement ratio of at least about 0.3/1.0.
³Silica fume/portland cement ratio of at least about 0.2/1.0.

For exterior applications, such as siding and roofing, Core Material III, set forth in Table 5, is preferred.

TABLE 5
CORE MATERIAL III (Exterior)

Process

| | | Silica Fume |
|---|---|---|
| Core Components¹ | Dry Blend² | Pre-Dispersed³ |
| Stucco | 40-50 | 40-50 |
| Portland Cement | 39-46 | 42-50 |
| Silica Fume | 12-14 | 9-10 |

¹All amounts in percent by weight.
²Silica fume/portland cement ratio of at least about 0.3/1.0.
³Silica fume/portland cement ratio of at least about 0.2/1.0.

The beta-gypsum component of the gypsum cement core material is calcium sulfate beta hemihydrate, commonly referred to as stucco. Beta-gypsum is traditionally less expensive than alpha-gypsum. Alpha-hemihydrate powder has a higher apparent density and smaller related surface area than beta-hemihydrate, resulting in a lower water requirement for the same workability and a higher compressive strength of the set material. However, boards made from the inventive composition have exhibited more than adequate strength for interior applications such as backer boards and floor underlayments and exterior applications, such as exterior sheeting and eaves.

The portland cement component of the gypsum cement core material according to 15 the invention may be any of Types I, II, III, IV, or V (or mixtures thereof) as set forth according to ASTM standards. However, Type III portland cement is preferred. Type III portland cement develops an earlier high strength than Type I and Type II portland cement.

Blended cements also may be used in the gypsum cement core material according to the invention. Blended cements are blends of portland cement with one or more pozzolanic materials such as fly ash and blast-furnace slag. The pozzolanic materials that are added to produce a “blend” with portland cement are distinguished from the pozzolanic aggregate component which may be used in core materials according to the invention in that the components of the cement “blend” have a particle size which is in the same range as the particle size range of portland cement, portland cement particle size may be defined as having approximately 15% of the particles retained on a 325 mesh screen. In other words, at least 85% of the portland cement particles pass through a 325 mesh screen (allows particles having a diameter of up to 45 microns to pass through).

The silica fume component of the binder according to the invention is an extremely active pozzolan and prevents the formation of ettringite. The silica fume for use in the invention preferably is very fine (particle average diameter of between about 0.1 microns and about 0.3 microns), has a high surface area (between about 20 meter^{2/}gram and about 30 meter²/gram as measured by BET (Baumer Emit & Tellers)), and is highly amorphous (between about 92 wt. % and about 97 wt. % amorphous SiO2 (glassy material)).

The silica fume component according to the invention includes at most about 0.6 wt. % alumina in the form of aluminum oxide (Al₂O₃). Preferably, the silica fume component according to the invention is made from the Silicon Metal Process. Certain silica fume producing processes, such as that from the ferrosilicon alloy industry, are not acceptable for use in the invention as such silica fume includes more than about 0.6 wt. % alumina. An example of a silica fume acceptable for use in the invention is set forth in Table 6 below.

Table 6 also includes a description of a rice-husk ash, which is an acceptable substitute for the silica fume component of the invention. Because rice-husk ash is currently more expensive to procure than silica fume, it is not as desirable for commercial applications.

TABLE 6
TYPICAL OXIDE ANALYSIS OF A SILICA FUME AND A
RICE-HUSK ASH FOR USE IN A BINDER OF THE INVENTION¹

| | Mass Percent² | | | | | |
|---|---|---|---|---|---|---|
| Source | SiO₂ | Al₂O₃ | Fe₂O₃ | CaO | MgO | Alkalies |
| Industry | 94.00 | 0.06 | 0.03 | 0.50 | 1.10 | 0.10 |
| Rice- | 92.15 | 0.41 | 0.21 | 0.41 | 0.45 | 2.39 |
| husk ash | | | | | | |

¹Table information taken from Malhotra, M. and Mehta, P. Kumar; Pozzolanic and Cementitious Materials, Advances in Concrete Technology, Vol. 1; p. 19; 1996 (Gordon & Breach Publishers, The Netherlands).
²Ignition loss for silica fume: 2.50; for rice-husk ash: 2.77.
³Silica fume from silicon metal industry

In contrast to the silica fume and rice-husk ash components, acceptable for use in the present invention, page 19 of Malhotra, M. and Mehta, P. Kumar, Pozzolanic and Cementitious Materials, Advances in Concrete Technology, Vol 1, discloses typical oxide analyses of silicon fumes made from the ferrosilicon alloy industry having SiO₂ amounts of as low as 83% and Al₂O₃ amounts from between 1.00% and 2.5%. Page 18 discloses oxide analyses of certain North American blast-furnace slags which have SiO₂ amounts of as low as 33% and Al₂O₃ amounts as high as 10.8%. Thus, not all pozzolans, and specifically, not all silica fumes, are acceptable for use according to the invention.

Core materials according to the invention may be prepared by either a “dry” or a “wet” process. In a “dry” process, the three, dry, binder components (calcium sulfate hemihydrate, portland cement, and silica fume) are fed to a mixer, such as a large batch or continuous mixer, and blended. The dry-blend is then mixed with water, and other components, as desired, to form a construction product. In a “wet” process, the calcium sulfate hemihydrate and the portland cement are dry-blended, but the silica fume is first mixed with water (i.e., dispersed in the water). The water containing dispersed silica fume is then mixed with the dry-blended calcium sulfate hemihydrate/portland cement mixture.

Core materials according to the invention made by either the “dry” or “wet” process may then be mixed with aggregate or other fillers to produce compositions according to the invention for use in a variety of applications. For example, core materials according to the invention may be mixed with pozzolanic aggregate and/or cellulosic fiber, to produce compositions according to the invention.

Compositions according to the invention may include about 10 wt. % to 100 wt. % of the above-described core materials (without aggregate), or may be mixed with about 90 wt. % to about 0 wt. % of an aggregate (preferably pozzolanic aggregate) or fiber (preferably about 15 wt % to about 30 wt. % cellulosic fiber), to form a construction material.

Basalt fiber-reinforced cementitious panels made with the above-described core materials, according to the invention, produce construction materials which set up quickly, exhibit high strength and durability, and are water and temperature resistant. Such products, produced from core compositions according to the invention, may be produced on a continuous line. Because core compositions according to the invention set up quickly (typically in three minutes or less), building materials made from compositions can be handled (e.g. sheets can be cut into smaller sheets or boards) much faster than products made from portland cement alone. Unlike traditional gypsum board, boards or other products made from gypsum cement core compositions do not require kiln drying, and in fact, kiln drying preferably should be avoided. Preferred, lower density core compositions preferably contain about 0.5% to about 2% by weight, preferably about 1% by weight, expanded polystyrene (eps) beads uniformly dispersed throughout the core composition. The eps beads can be included in the core composition in place of at least a portion of higher density aggregate, such as clay and/or stone aggregate, as a core density management expedient, and aids in providing the core material with entrapped air, without the need for foaming agents, or with less foaming agent.

A pozzolanic aggregate which may be mixed with a master blend core material may include natural or man-made aggregate that contains a substantial percentage of amorphous silica. Natural pozzolanic aggregates are of volcanic origin and include trass, diatomaceous earth, pumice, and perlite. Man-made pozzolanic aggregates include fly ash and FILLITE (hollow silicate spheres which may be made from fly ash; produced by Fillite Division of Boliden Intertrade, Inc. Atlanta, Ga.). As compared to portland cement “blend” components of the invention, pozzolanic aggregates used with master blend binders to provide compositions according to the invention are defined herein as having an average particle size larger than that of portland cement (i.e., average particle diameter larger than 45 microns).

Pozzolanic aggregates contain a substantial amount of amorphous silica which possesses little or no cementitious properties. However, in the presence of moisture, pozzolanic aggregates have surfaces that are chemically reactive with calcium hydroxide at standard temperatures to form hydrated calcium silicate (CSH) which, in core compositions and methods according to the invention, are believed to become a homogeneous part of a cementitious system due also to the presence of the finely divided silica fume component of the invention. Core compositions according to the invention which include both a pozzolanic aggregate and silica fume (or rice-husk ash), result in cementitious materials wherein the transition zone between the aggregate and a cement paste is densified and thus produces a cured product of higher compressive strength than compositions which utilize a pozzolanic aggregate alone or silica fume with an inert aggregate. It is believed that the mechanism which causes changes in the microstructure of compositions according to the invention to result in higher compressive strengths is associated with two effects: a pozzolanic effect and a micro-filler effect (due to the fine size and spherical shape of the silica fume).

Cellulosic fibers may be mixed with the gypsum cement core material to form a core composition useful in accordance with the invention. Preferred fibers are wood and paper fibers, including recycled waste paper fibers and saw dust, other ligneous materials such as flax and cotton, and mixtures of such fibers. Wood fiber is a particularly preferred cellulosic fiber component for a composition according to the invention.

Most preferably, the fiber is obtained from debarked wood which is refined to long thin flakes having a thickness of about 0.008 inches (about 0.2 mm) to about 0.013 inches (about 0.33 mm) and a length of up to about 1.18 inches (about 30 mm). The flaked wood is then milled and screened and possibly further refined using known processes in order to provide fibers or fiber flakes of substantially constant geometry.

If wood fiber, such as paper, material is used in the core composition, the paper is shredded, preferably with a hammermill/screen assembly. The shredded paper is then preferably dry-refined to result in fibers of substantially constant geometry.

As stated above, core compositions according to the invention for use in interior applications preferably are made using the Core Material I set forth in Table I. Such a core composition may be mixed with cellulosic fiber to produce a basalt-reinforced fiberboard according to the invention. Preferably, interior fiberboards according to the invention include (i) about 70 wt. % to about 90 wt. % of the Core Material I disclosed in Table I; and (ii) about 30 wt. % to about 10 wt. % of a fiber component. Depending on the application, it may be desirable to utilize the Core Material II disclosed in Table II for a fiberboard interior application, or even the Core Material III disclosed in Table III if the fiberboard is to be used in an exterior application subjected to the elements. For example, a preferred composition for making outdoor siding includes (i) about 70 wt. % to about 75 wt. % of the Core Material III disclosed in Table III; and (ii) about 30 wt. % to about 25 wt. % of a wood fiber component. Another preferred composition for making outdoor siding includes (i) about 82 wt. % to about 85 wt. % of the Core Material III disclosed in Table III; and (ii) about 18 wt. % to about 15 wt. % cellulosic fiber component.

The fiber component is preferably selected from wood fibers, plant fibers, and paper fibers. It also may be glass fibers, basalt fibers, polyethylene fibers, polypropylene fibers, nylon fibers, and other plastic fibers.

A core material according to the invention may be manufactured by the following process:

Raw gypsum may be calcined at about 160° C. (320° F.) to about 175° C. (347° F.) to form calcium sulfate hemihydrate. The calcined gypsum can be post-ground to a finer particle size if, for example, certain strengths, water requirements, and working properties are desired.

All components of the composition, including gypsum, cement, silica fume, water, fiber, and any other additives preferably are added to the batch on a weight basis. Moisture in the wood fiber is measured and compensated for in the make-up water when mixed.

The gypsum powder is fed to a mixer, such as a large batch or continuous mixer, and blended with portland cement and silica fume. Alternatively, only the gypsum powder and the portland cement are dry mixed and the silica fume is dispersed in water.

In a second mixer, the fiber (if any) is mixed with water (or the silica fume/water mixture) to allow the fiber/water mixture to loosen. The blended dry components of the binder are then added to the fiber/water mixture (or the fiber/water/silica fume) and intensively mixed. Although water may be added to the binder/fiber mixture (or to the binder prior to mixing with the fiber), preferably, the water is added to the fiber and then the dry binder components are added to the water/fiber mixture.

Most preferably, the water addition to the fiber and the subsequent binder addition to the wetted fiber are performed with the aid of computer control so that it is possible to add to the fiber the total quantity of water required for the process (i.e. a slight stoichiometric excess amount of water required for hydration), and then vigorously mix the wetted fiber with the binder.

Other ingredients, such as set control additives (e.g. accelerators), water reducing agents, water repellent additives, retarders, and latex or polymer modifiers may be added to the fiber/binder mixture. Some additives may be added to the dry binder mixture prior to mixing with the wet fiber. Preferably, the composition includes about 0.01 wt. % to about 1.5 wt. % retarder, based upon the total weight of the composition.

The mixed composition is then conveyed directly to a forming machine which spreads an endless mat of core material onto a basalt fiber-containing mat held on an elongated belt of a continuous process through ovens preferably at about 180° F. for hydration and curing in-line such that setting time is reduced, minimized or accelerated. A second basalt fiber mat is applied to an upper surface of the core material. The core composition having a basalt fiber mat embedded, preferably on both major surfaces, enters the series of ovens at about 160° F. to 200° F., preferably about 180° F., and after setting and curing, may be cut into sections, and exits on a conveyor belt in the form of an endless board-ribbon or panel sections.

The board-ribbon (or panel sections) leaving the ovens has sufficient green strength so that it can be transferred onto a conveyor which will carry the board forward to a cutting station.

Finally the board panels are trimmed and, if desired, split lengthwise to a final dimension. Boards are typically cut into 3 ft. (0.9 meter)×5 ft. (1.5 meter) sheets, and have a thickness between about ½ inch (about 1.3 cm) and about ⅝ inch (about 1.6 cm).

Core compositions for construction materials, such as backer boards and floor underlays, according to the invention preferably are made from the Core Material II disclosed in Table II. Such core compositions may include about 10 wt. % to about 50 wt. % of a pozzolanic aggregate (about 25 wt. % to about 35 wt. % is preferred). A preferred aggregate for use in such construction materials is pumice. Pumice may be desirable as it is relatively light weight and can be sized to result in a product of desirable strength and physical properties. For example, Hess Pumice Products Inc. manufactures a size No. 10 pumice aggregate that measures about 93% greater than 1400 microns, while the size No. 5 pumice aggregate has a particle size measurement of about 23% greater than 1400 microns.

Although aggregates such as calcium carbonate, crystalline silica and different types of clay could be included in the composition, it has been found that the use of a pozzolanic aggregate results in a product according to the invention having superior properties. As explained above, this is believed to occur because the surfaces of the pozzolanic aggregate filler react with free lime to form hydrated calcium silicate (pozzolanic reaction) which becomes part of the product matrix. Such a reaction is only possible with pozzolanic aggregates.

A backer board according to the invention, comprises a core made from a cementitious core composition according to the invention and adjacent basalt fiber cover sheets and disposed at, and embedded in, either side thereof. Such a board may be manufactured by the following process:

Raw gypsum may be calcined at about 160° C. (320° F.) to about 175° C. (347° F.) to form calcium sulfate hemihydrate. The calcined gypsum can be post-ground to a finer particle size if, for example, certain strengths, water requirements, and working properties are desired. In a “dry” blend process according to the invention, the gypsum powder is fed to a mixer and blended with portland cement, silica fume and optionally, a pozzolanic aggregate. The pozzolanic aggregate may be pumice, perlite, trass, or fly ash or a mixture thereof. Cellulosic fiber may be added to the binder/aggregate mixture. Other ingredients that may be included in the composition are set control additives (e.g. accelerators), water reducing agents, water repellent additives and latex or polymer modifiers. The resulting dry blend is combined with a slight stoichiometric excess of water to produce a slurry.

In a “wet” process according to the invention, the silica fume component is first dispersed in water. The gypsum and portland cement are dry blended, followed by mixing with the silica fume/water mixture to produce a slurry. In comparison to the “dry process” where the ratio of silica fume to portland cement should be at least about 0.30/1.0, utilizing a “wet” pre-dispersed silica fume, the silica fume to portland cement ratio may be lowered to a minimum of about 0.20/1.0.

The binder/aggregate (and/or fiber) slurry, which forms the core 3 of the board, may be poured onto a lower, continuous cover sheet 5 which is disposed on a conveyor.

Then, an upper continuous cover sheet 7 is placed on the core as it moves on the conveyor. The basalt fiber cover sheets may be non-woven or woven materials, or a scrim. As the slurry sets, the fabric or scrim is embedded into the slurry core material matrix during the forming process. As the covered board moves along the conveyor line in a continuous sheet, the board gains sufficient strength so that it can be handled. The board is then cut into sections, (for backer boards, usually either 3 ft.×5 ft. or 3 ft.×4 ft. sheets) and transferred to pallets. The board thickness preferably ranges between about ⅛ inch and about ⅝ inch. The boards are then preferably stacked and cured from one to seven days (particularly preferred about three days) at a temperature of about 16° C. (60° F.) to about 27° C. (80° F.) (i.e. room temperature) and a humidity of about 40% to about 70%, after which the boards may be sent to a customer. The stacking of the boards advantageously provides a moist environment for curing. The boards may be cured at temperatures and humidities outside of the above-stated ranges resulting in an acceptable product. However, this may extend the curing time. A board according to the invention usually substantially reaches a majority of its strength about fourteen to about twenty-eight days after formation.

When preparing a board or other product according to the invention, the forced drying required for gypsum board should be avoided. An alternative curing procedure is to cover or wrap the boards in plastic wrapping for about three to seven days, depending upon the formulation of the composition, to retain moisture for continuous curing. Such covered boards have exhibited about 50% higher strength than normal gypsum boards of the same density. Also, the covered boards develop about 70% to about 80% of their ultimate strength in three days. Some form of moderate drying (110° F.±4°) may be needed for some products.

When a board or other product, such as a floor underlayment, having a thickness of about ⅛ inch is desired, the cementitious core composition thereof is preferably made from Core Material I which is then mixed with up to about 50 wt. % pozzolanic aggregate filler, resulting in a very strong thin product, especially useful, for example, for floor underlayment.

Compositions according to the invention may also be used to prepare self-leveling floor compositions and road patching materials. Such materials are preferably made from the Core Material III disclosed in Table III. The binder is then mixed with aggregate, such as a local quartz sand, to form the floor or road patching material.

Preferably, a self-leveling floor core composition according to the invention includes (i) about 15 wt. % to about 75 wt. % the Core Material III disclosed in Table III; and (ii) about 85 wt. % to about 25 wt. % aggregate in the form of sand. The aggregate component may further include up to about 2 wt. % FILLITE pozzolanic aggregate. Because of its low density, FILLITE addition of amounts as low as about 1 wt. % of the composition provide a considerable volume of aggregate (see Example 2, Table II for FILLITE physical properties).

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1

A master blend core composition according to the invention having a silica fume/portland cement ratio of about 0.3/1.0 was prepared with the components set forth in the amounts stated in Table 7 below:

TABLE 7

| Material | Approx. Weight Percent |
|---|---|
| Beta-gypsum (Stucco) | 74 |
| Type III Portland Cement | 20 |
| Silica Fume | 6 |

A self-leveling floor core composition #1 according to the invention was prepared with the components set forth in the amounts stated in Table 8 below. A cementitious core composition #2 with components also set forth in the amounts stated in Table 8 below (which did not include a pozzolanic aggregate) was also prepared.

TABLE 8

| | Composition #1 | Composition #2 |
|---|---|---|
| Material | (weight percent) | (weight percent) |
| Core Material from | 54.04 | 48.86 |
| Table V | | |
| FILLITE 500 | 1.35 | 0.0 |
| Pozzolanic Aggregate¹ | | |
| Sand (quartz; | 43.26 | 49.4 |
| crystallized silica) | | |
| W.R.A² | 0.9 | 0.82 |
| Retarder³ | 0.06 | 0.06 |
| Anti-foaming agent⁴ | 0.26 | 0.33 |

¹Fillite Division of Boliden Intertrade, Inc., Atlanta Georgia. Hollow silicate spheres with the following physical properties: average particle density of 0.6-0.8 g/cc; average bulk density of 0.35-0.45 g/cc; and typical particle size of 5-300 microns. The shell composition includes 27 wt. % to 33 wt. % Al₂O₃, 55 wt. % to 65 wt. % SiO₂, and a maximum of 4 wt. % Fe₂O₃.
²Water reducing agent or wetting agent including lignosulfonates and/or naphthalene sulfonates manufactured by Georgia Pacific Corp. and Henkel Corp., respectively.
³A natural protein-based material.
⁴A vegetable oil-based dry powder.

In order to form a floor composition of a smooth consistency, core composition #1 was mixed with about 26 wt. % water and core composition #2 was mixed with about 24 wt. % water. The density of core composition #1 was 107 lbs./ft³. The density of core composition #2 was 111.62 lbs./ft³.

### Example 2

A master blend core composition according to the invention having a silica fume/portland cement ratio of about 0.3/1.0 was prepared with the components set forth in the amounts stated in Table 9 below:

TABLE 9

| Material | Approx. Weight Percent |
|---|---|
| Beta-gypsum (Stucco) | 40 |
| Type III Portland Cement | 46 |
| Silica Fume | 14 |
| Accelerator¹ | 0.35 |

¹BMA (board milling accelerator, a fine-ground gypsum produced by National Gypsum Company).

The core materials identified in Table 9 were dry mixed to form the master blend binder. Then, about 75 wt. % of the core material was mixed with about 25 wt. % pumice aggregate (Hess Products, Inc., Malard City, Id.) and 100 grams thereof was mixed with 43 grams of water. To improve the workability of the mixture, a water reducing agent (lignosulfonates and/or naphthalene sulfonates manufactured by Georgia Pacific Corp. and Henkel Corp., respectively) was added.

For other core composition, the master blend disclosed in Table 8 was blended with up to about 50 wt. % pozzolanic aggregate filler (pumice or perlite), with and without foaming agent.

### Example 3

A master blend core composition according to the invention having a silica fume/portland cement ratio of about 0.3/1.0 was prepared by dry-mixing the components set forth in the amounts stated in Table 10 below:

TABLE 10

| Material | Weight Percent |
|---|---|
| Beta-gypsum (Stucco) | 40 |
| Type III Portland Cement | 46 |
| Silica Fume | 14 |

About 75% by weight of the dry-blended core composition identified in Table 10 was mixed with about 25 wt. % (dry weight) of wood fiber that had been mixed with water (slight stoichiometric excess). The wetted fiber and binder were vigorously mixed, formed into mats and pressed into sample core composition boards, without basalt fiber reinforcing mats, using a laboratory press (manufactured by Bison GmbH, Springe, Germany). The pressing conditions included 30 kg/cm² pressure; press temperature of about 25° C.; and a press time of three hours.

### Example 4

A master blend gypsum cement core material according to the invention was prepared with the components set forth in the amounts stated in Table 11 below:

TABLE 11

| Material | Approx. Weight Percent |
|---|---|
| Beta-gypsum (Stucco) | 61 |
| Type III Portland Cement | 26 |
| Silica Fume | 13 |

A cementitious core composition according to the invention was then prepared with the binder and the components set forth in the amounts stated in Table 12 below:

TABLE 12

| Material | Weight Percent |
|---|---|
| Core Material from Table IX | 59.3 |
| Pumice Aggregate | 39.5 |
| W.R.A.¹ | 0.87 |
| Water Repellent Agent² | 0.11 |
| Accelerator | 0.058 |
| (ball-milled CaSO₄ · 2H₂O gypsum | |
| dihydrate³) | |

¹Water reducing agent or wetting agent including lignosulfonates and/or naphthalene sulfonates manufactured by Georgia Pacific Corp. and Henkel Corp., respectively.
²A silicone product or like material, e.g., Veoceal 2100 and Veoceal 1311 (both TM designations of products manufactured by Wacker Silicone Corp.)
³See U.S. Pat. Nos. 3,920,465, 3,870,538 and 4,019,920.

The materials identified in Table X were mixed and 100 grams thereof was mixed with 35.6 grams of water. About 1 wt. % to about 5 wt. % of a polymer latex (acrylic or SBR) was added to the mixture to improve flexibility. The mixture can then be formed into boards according to the invention using a upper and/or lower basalt fiber reinforcing mat/scrim composites.

In the gypsum cement core compositions according to the invention, the pumice becomes part of the hydrated calcium silicate (CSH) matrix, substantially eliminating any transition zone 32 between the pumice aggregate and the cement paste. This indicates that a pozzolanic reaction occurs between the aggregate surface and the binder, thus improving mechanical properties.

### Example 5

The master blend core material set forth in Table 11 of Example 4 was blended with the components disclosed in Table 13 below to form a cementitious core composition according to the invention.

TABLE 13

| Material | Weight Percent |
|---|---|
| Core Material from of Table IX | 73.8 |
| Pumice Aggregate | 24.6 |
| Perlite | 1.47 |
| W.R.A.¹ | 0.87 |
| Water Repellent Agent² | 0.11 |
| Accelerator | 0.042 |
| (ball-milled CaSO₄ · 2H₂O gypsum | |
| dihydrate³) | |
| ¹Water reducing agent or wetting agent including lignosulfonates and/or naplithalene | |
| # sulfonates manufactured by Georgia Pacific Corp. and Henkel Corp., respectively. | |
| ²A silicone product or like material, e.g., Veoceal 2100 and Veoceal 1311 (both TM | |
| # designations of products manufactured by Wacker Silicone Corp.) | |

³See U.S. Pat. Nos. 3,920,465, 3,870,538 and 4,019,920.

The materials identified in Table 13 were mixed and 100 grams thereof was mixed with 35.6 grams of water. About 1 wt. % to about 5 wt. % of a polymer latex (acrylic or SBR) was added to the mixture to improve flexibility. The mixture then can be formed into boards having a basalt fiber-containing mat/scrim or fabric embedded in upper and/or lower surfaces of the core composition according to the invention.

It is noted that the silica fume/portland cement ratio of the core compositions produced in Examples 4 and 5 was at least about .50/1.0. Although this ratio produces an acceptable core composition, it is not as cost effective as core compositions made from a “dry” blend process having a silica fume/portland cement ratio of 0.30/1.0.

### Example 6

A master blend core composition was prepared in the amounts stated in Table 14 below.

TABLE 14

| Material | Approx. Weight Percent |
|---|---|
| Beta-gypsum (Stucco) | 40 |
| Type III Portland Cement | 46 |
| Silica Fume | 14 |

The gypsum and portland cement components of the core composition identified in Table XII were dry mixed. The core composition was prepared by pre-dispersing silica fume in water, followed by mixing the silica fume/water mixture with the dry-blended gypsum/portland cement mixture. For each 600 grams of binder, 360 cc of water was used.

### Example 7

A master blend core composition according to the invention was prepared with the components set forth in the amounts stated in Table 15below:

TABLE 15

| Material | Approx. Weight Percent |
|---|---|
| Beta-gypsum (Stucco) | 42 |
| Type III Portland Cement | 48.4 |
| Silica Fume | 9.6 |

Rather than dry-blending the gypsum, portland cement, and silica fume components, the silica fume was pre-dispersed in water and the silica fume/water mixture was then mixed with a dry blend of gypsum and portland cement. For each 600 grams of binder, 360 cc of water was used.

The following tables give additional exemplary compositions for the slurry and core mix in accordance with the present inventions.

TABLE 16

| | Generic Formula | Preferred Specific Formula |
|---|---|---|
| Slurry | Percentage in weight | Percentage in weight |
| Portland cement | Type 1 Portland cement 50-80% | Type 1 Portland 81% +/− 5% |
| | Type 2 Portland cement 50-80% | |
| | Type 3 Portland cement 50-80% | |
| | Type 4 Portland cement 50-80% | |
| Fly ash | 0-30% | 0% |
| Calcium sulfate | 0-10% | 0% |
| Calcium carbonate | 0-10% | 0% |
| High alumina cement | Blaine 4000 to 5000: 2-20% | Blaine 4000 to 5000 |
| | Blaine 5000 to 6000: 1-15% | 10 +/− 5% |
| Water | 5-20% | 8% +/− 2% |
| Air entraining agent | 0-5% | 0% |
| Plasticizer | 0-5% | 0.8% +/− 0.2% |
| TOTAL | | 100 +/− 5% |

TABLE 17
For the Core Formulation

| | Generic Formula | Preferred Specific formula |
|---|---|---|
| Core | Percentage in weight | Percentage in weight |
| Portland cement | Type 1 Portland Cement 30-50% | Type 1 Portland cement 34 +/− 2% |
| | Type 2 Portland Cement 30-50% | |
| | Type 3 Portland Cement 30-50% | |
| | Type 4 Portland cement 30-50% | |
| High alumina | Blaine 4000 to 5000: 2-20% | Blaine 4000 to 5000 4% +/− 2% |
| cement | Blaine 5000 to 6000: 1-15% | |
| aggregate | Mortar sand 0-1/16″ 30 to 60% | mortar sand 48% +/− 2% |
| | Concrete sand 0-⅛″ 30 to 60% | |
| | Expanded Clay 15 to 50% | |
| | Expanded schist 15 to 50% | |
| | Expanded slag 15 to 50% | |
| | Expanded vermiculite 2-10% | |
| | Expanded perlite 2-10% | |
| Polystyrene | flame retardant 0-⅛″ dia | 1% +/− 0.2% |
| Water | drinkable 10-30% | drinkable 11 +/− 5% |
| Air entraining | Generic surfactant 0-2% | Generic surfactant |
| agent | Deceth sulfate 0-2% | 0.015% +/− 0.005% |
| | Laureth sulfate 0-2% | |
| Total | | 100% +/− 5% |

TABLE 18
Slurry

| | | |
|---|---|---|
| Portland cement | Ciment St-Laurent Lafarge | 81% +/− 5% |
| | Ciment Quebec | |
| Accelerator | Lafarge Calcium Alumninate | 10 +/− 5% |
| | Lehigh Cement | |
| Water | N/A | 8% +/− 2% |
| Plasticizer | Euclid | 0.8 +/− 0.2% |
| | Master-Builders | |
| | Grace | |
| Total | | 100 +/− 5% |

Optional Edge Reinforcement

In accordance with the present invention the optional reinforcement of the edges and margins of a cementitious board or panel may be accomplished by using a separate type of woven or non-woven mesh or fabric as compared with the basalt-fiber-containing reinforcing mesh used for the major surface(s). Advantageously, the reinforcing mesh for the edge face may be a non-woven non-oriented mesh, preferably also of basalt fibers. For example, an optional reinforcing mesh for the longitudinal edges may have relatively tight interstices as compared with a basalt fiber reinforcing mesh for one or both major surfaces, e.g., 2 to 10 ounces per square yard. The relatively tight interstices in the edge reinforcing materials makes attaclunent of the board to a wall framework with nails or screws more secure.

The fibers in a non-woven mesh for optional reinforcement of a longitudinal marginal edge may be either randomly distributed or orientated. In the first case the longitudinal edges of the board will have substantially the same breaking strength in the longitudinal and the transverse directions. In the latter case, the longitudinal edges of the board can have high strength in the transverse direction but a lower strength in the longitudinal direction or vice versa. Thus, by varying the characteristics of the fabric used for longitudinal edge reinforcement, the edges may be made stronger in a particular direction, or additional strength can be provided in desired locations, e.g., along the board edges, by using a fabric or mesh of appropriate fiber distribution.

The mesh size and the fiber diameter for the preferred non-woven oriented mesh used to reinforce the longitudinal marginal edge face adjacent the longitudinal edge face may also be selected according to the strength desired in the longitudinal edge. However, a mesh for a longitudinal edge margin face may, for example, have a tighter weave or interstices than the basalt fiber material used for the reinforcement of the major surface(s), for example, a thread or mesh count tighter than 10×8. Thus, the reinforcing meshes for the marginal edge faces may have relatively small openings such as, for example, meshes with a 16×10 count per inch may be used so as to secure the desired or necessary penetration of the fabric along the edge margins with the cementitious composition.

The optional non-woven mesh for reinforcing a longitudinal marginal edge may, for example, comprise fleece-like mats or felts of fibers arranged in a non-oriented manner. The non-woven non-oriented mesh longitudinal edge reinforcing material may be three dimensional in nature with the fibers thereof defining interconnecting voids. In general, the optional non-oriented mesh which may be employed in the reinforcement of the longitudinal marginal edges are generally those in which the voids are relatively small in size, i.e., the fibers in the mesh, mat or felt are relatively tightly packed, e.g., of 2 to 4 ounces per square yard.

If desired, the reinforcing basalt fiber mesh used to reinforce the major surfaces of the panel may be a mixture of two or more different types of fibers, or two or more mats of different fibrous material may be used, one being predominantly (at least 50% by weight) basalt fibers, preferably about 75% to 100% basalt fibers, with the preferred non-basalt fiber, if any, being glass. The basalt fibers used to reinforce one or both major surface of the mat may be multi-filament or monofilament, preferably multi-filament in the form of strands or rovings—strands being formed from a plurality of, for example, 2 to 50 basalt fiber filaments, and rovings being formed from 2 to 20 strands.

In accordance with an important feature of the present invention, the basalt fiber major surface reinforcing members are extremely flexible for the purpose of reinforcing gypsum and cementitious core materials and, therefore, can be manufactured from basalt fibers that are thicker than glass fibers, or made into woven or non-woven fabrics or scrims that are thicker than prior art glass fiber fabrics, while retaining major surface reinforcing fabric flexibility. The extreme flexibility of basalt fiber meshes, scrims and fabrics provides unexpected ease in securing the major surface reinforcing meshes, scrims or fabrics to the major surface(s) of the cementitious core material, even at the thicknesses of 0.1 mm to 5 mm thick meshes, fabrics or scrims.

A basalt fiber reinforcing mesh for the major surfaces may be bonded to the core in any suitable fashion keeping in mind the reinforcing role that these meshes are to play. A reinforcing mesh may, for example, be bonded to a core by a cementitious slurry, for example, a portland cement slurry, or a gypsum slurry, or may be bonded by a cementitious component of a core mix extending through the openings in the mesh.

The reinforcing basalt fiber mesh, fabric or scrim of the major surface(s), and the optional mesh disposed about the longitudinal marginal edge faces may be held in place in the set product by allowing the cementitious core composition to infiltrate interstices of such a mesh, fabric, or scrim such that at least some of the fibers are embedded in the hardened cementitious composition. In this case, in order to facilitate such penetration of a mesh by the cementitious composition, the meshes or fabrics should comprise a sufficient degree of void area so as to allow the unhardened cement composition to penetrate the mesh or fabric. In other words, a reinforcing mesh adhered to a major surface of a core may be pervious meshes (i.e., pervious to cementitious slurry); the openings in a mesh, scrim or other fabric in this case should be sufficiently large to permit passage of the mesh bonding material, such as a portland cement slurry, i.e., such that a mesh, scrim or fabric is cemented to or embedded in a major surface of the core material.

In accordance with the present invention a cementitious panel may be produced employing a core mix alone or, if desired, by also employing a cementitious slurry.

By way of example only, a cementitious panel in accordance with the present invention, may be obtained by following the immediately herein below described steps. A first web of basalt fiber reinforcing mesh, fabric or scrim may first be provided for a core face which, during manufacture, forms part of the bottom layer of the panel and which, optionally, is not as wide as the panel width. A marginal section or area of the first web on each side of the center may be disposed to overlap a portion of an edge reinforcing web or mesh or fabric leaving outer edge portions thereof uncovered thereby; the uncovered portion may be folded over to wrap each of the two edges of the core layer and also to extend onto the top face of the core layer and overlap the upper major surface basalt fiber reinforcement mesh, fabric or scrim.

A cementitious slurry may first be applied onto the first, basalt fiber mesh or fabric so as to embed it therein and may be applied so as to leave uncovered at least an outer portion of the edge reinforcing webs for covering the longitudinal edge faces. The center section of the first, basalt fiber web receives the core layer slurry and the basalt fiber mesh or fabric may be laid down so as to leave exposed outer marginal portions of the basalt fiber mesh or fabric to be wrapped about the longitudinal edges. A second web of basalt fiber reinforcing mesh or fabric (which forms the top layer of the panel), and which is of the same width as the first web, may be laid down on top of the core layer so as to overlay it. The top basalt fiber mesh or fabric is pushed just under the upper surface of the core material so as to be embedded in the top surface. Bonding material, such as a portland cement slurry may also be applied to the second basalt fiber web either before or after it is laid down onto the core layer.

A core mix may, for example, comprise water, a cementitious material (i.e., a hydraulic cement which is able to set on hydration such as, for example, portland cement, magnesia cement, alumina cement, gypsum, and the like or a blend thereof) and an aggregate component selected from among mineral and/or non-mineral (e.g., organic) aggregate(s). Lighter weight core compositions include about 0.5% to about 2% by weight, preferably about 1% by weight of a density management component, such as expanded polystyrene beads (eps). The ratio of mineral aggregate to hydraulic cement may be in ratio of 1:6 to 6:1. The ratio of non-mineral aggregate to hydraulic cement may be in ratio of 1:100 to 6:1.

The particle size distribution of the aggregate may vary over a wide range, e.g., up to ⅓ (e.g., ¼) of the thickness of the panel or smaller, such as, for example, from 1/32 of an inch to ¼ of an inch.

Aggregate for use in the cementitious core mix composition may be selected in accordance with the desired density of the finished panel. Aggregate may, for example, have a density of up to 120 pounds per cubic foot. For example, lightweight aggregates such as obtained from expanded forms of slag, clay, shale, slate, pearlite, vermiculite and the like may produce panels having a density of from about 80 to about 115 pounds per cubic foot. On the other hand, a material such as closed-cell glass beads, or a plastic such as polystyrene beads, may be used to obtain a panel having a density of from about 40 to 70 pounds per cubic foot or lower.

The core mix preferably comprises a lightweight mineral and/or non-mineral (e.g., organic) aggregate(s) (e.g., sand, expanded clay, expanded shale, expanded perlite, expanded vermiculite expanded closed-cell glass beads, closed-cell polystyrene beads and/or the like). Suitable lightweight aggregates, may, for example, in particular, be cellular in nature. A preferred non-mineral, lightweight aggregate is, for example, expanded closed-cell polystyrene beads.

A cementitious slurry may, for example, comprise water and a cementitious material (i.e., a hydraulic cement as described above). A cementitious slurry, such as a portland cement slurry, is strongly basic or alkaline having a pH of at least 11, due to the presence of calcium hydroxide, e.g., a pH of from 11 to 14, such as a pH of 11 to 13, e.g., a pH of 12.5 to 13. Such a slurry tends to react with, or have an affinity for, base-reactive surfaces and consequently have a decided tendency to cling to these surfaces. Surprisingly, basalt fibers, which are alkali resistant, bond tenaciously to such cementitious core materials, particularly when embedded therein prior to curing or hardening of the core material.

As mentioned above, a reinforcing basalt fiber mesh, fabric or scrim is adhered to one or both major surfaces of a cementitious, e.g., portland cement and/or a gypsum-based, core in forming a panel. In accordance with the present invention, a basalt fiber reinforcing material is embedded in a major surface of the core such that the basalt fiber mesh, fabric or scrim is disposed at or near the surface of the board or panel to enhance the strength of the board or panel. The strength of the panel is unexpectedly enhanced if a basalt fiber mesh, fabric or scrim is adhered at a core surface. The embedding of the reinforcing basalt fibers just beneath the surfaces of the core may, for example, be carried out at a depth of submersion from, the example, about 0.5 mm to about 2.0 mm or less, preferably 0.5 mm or less.

The core mix may be applied in any desired thickness, for example, so as to be applied to obtain a panel having the standard thicknesses of plasterboard. A panel may be produced in varying thickness depending upon end use: e.g., in thicknesses of ¼″, ⅜″, ½″, ⅝″, ¾″, 1″, and the like.

In accordance with the present invention a cementitious core mix composition may be used which, when cured, has cells present due to entrained or entrapped air. Accordingly, a core mix may, for example, include a suitable air entrainment or foaming agent in such amounts so as to produce the desired degree of air entrainment.

As mentioned above, the first major surface basalt fiber mesh, fabric or scrim is laid down on a suitable carrier support web; the carrier support web may, for example, advantageously be of a non-stick material relative to the cementitious material, i.e., the carrier on which the board is formed may be of a material to which the cementitious slurry does not readily adhere, exemplary materials are polyethylene or polypropylene film, 1.0 to 5.0 mils thick: polyethylene or silicone release coated Kraft paper having at least 30 pounds to 100 pounds per square foot of strength.

The optional edge reinforcements may, for example, extend inwardly from a longitudinal edge face approximately 0.511 to 2.511.

Other optional core components may be added to the cementitious material, for example, an air entraining agent. Air entraining agents work like a soap except the agents are able to create very small air bubbles that are visible with a microscope. The air entraining agent is not necessarily used to make the board lighter. A given amount of a specific type of air entraining agent may be chosen to create air bubbles which will inhibit damage that can be caused by freezing and thawing cycles. The bubbles may be so small that water does not have a tendency to penetrate them, so the water absorption of the board is not affected.

A panel in accordance with the present invention may thus comprise relatively thin basalt fiber surface reinforcement elements on the faces thereof so as to provide the panel with a relatively high strength. The panel may also have a core which is relatively readily penetrable by nails, screws and other fasteners. A panel having basalt fiber surface edge reinforcement layers are unexpectedly strong and hard such that a nail or screw may be driven through the edge of the panel.

The invention will hereinafter be described in more detail in relation to the drawings by way of example only, in terms of a panel (e.g., wallboard) having a cementitious core comprising a hydraulic cement such as portland cement and/or gypsum, with or without an aggregate, the aggregate, if any, preferably being of a lightweight type, such as expanded polystyrene beads. The drawings are schematic in nature, are not drawn to scale and in some cases elements are exaggerated for purpose of illustration only.

The preferred embodiment shown in the drawings includes the preferred longitudinal side edge reinforcement, as disclosed in this Assignee's co-pending application Ser. No. 09/049,915, filed Mar. 30, 1998, hereby incorporated by reference. However, it should be understood that the cementitious panel having basalt fiber reinforcing components embedded in one or both major surfaces, can be manufactured without incorporating the side edge reinforcement, or can be the reinforcing structures shown in the prior art, for example, the edge reinforcement of U.S. Pat. Nos. 5,030,502 or 5,221,386, both of which are incorporated herein by reference. If the side edges are not reinforced, the major surface reinforcing basalt fiber webs 3 and 12 are essentially coextensive with the upper and lower surfaces of the cementitious core (±2 centimeters).

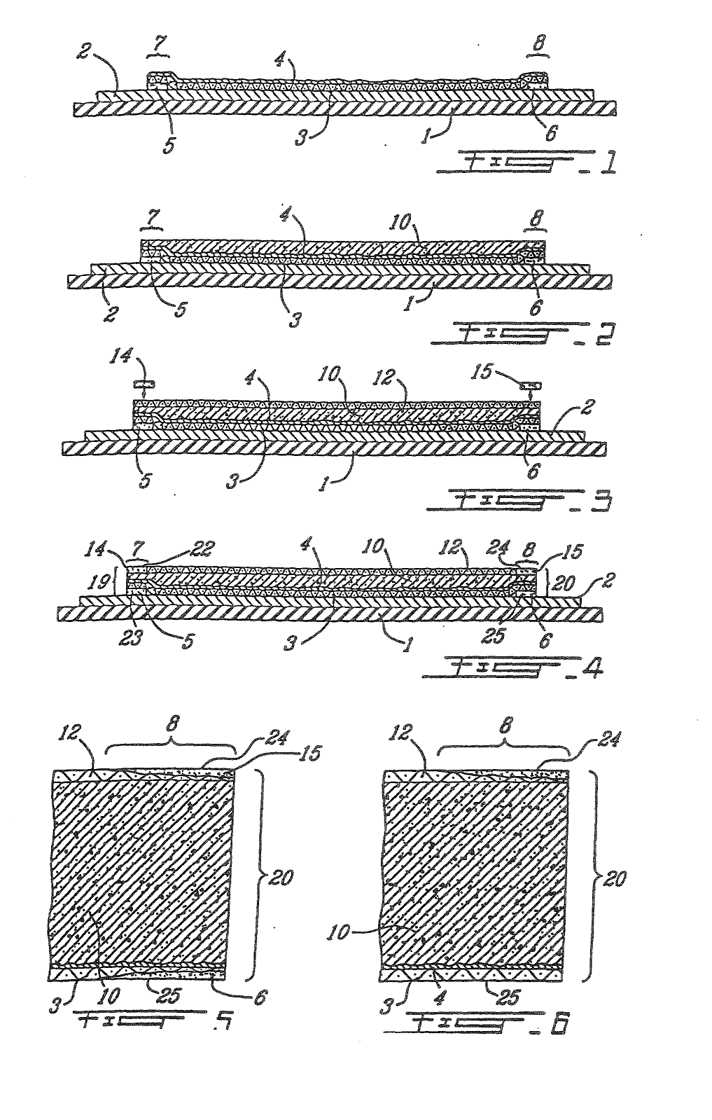

FIGS. 1 to 4 illustrate in a series of cross-sectional views a sequence of steps in a method for the manufacture of an example edge reinforced panel in accordance with the present invention wherein the longitudinal edge faces are not closed off. In these figures the reference numeral 1 indicate a conveyor belt, i.e., a support member and the reference numeral 2 indicates a protective film which is supported and advanced by the conveyor belt 1. The protective film 2 is wider than the panel to be made.

In FIG. 1 a web of a first non-woven basalt fiber mesh 3 is shown with a previously applied portland cement slurry 4 deposited thereon across its breadth in a layer. The first non-woven basalt fiber mesh 3 has also previously been laid on the protective film 2 such that it overlaps a pair of first bands 5 and 6 of the polypropylene non-oriented mesh which were previously laid on the protective film 2 in parallel spaced apart relationship, the first bands 5 and 6 being disposed along margin sections 7 and 8. As may be seen the margin sections 7 and 8 are covered by the first non-woven basalt fiber mesh 3 and by the slurry 4 such that both the first non-woven oriented basalt fiber mesh 3 and the first bands 5 and 6 are slurried.

In FIG. 2 a core mix 10 is shown as having been laid upon the slurried first non-woven basalt fiber mesh 3 so as to be deposited across the breadth thereof in a layer.

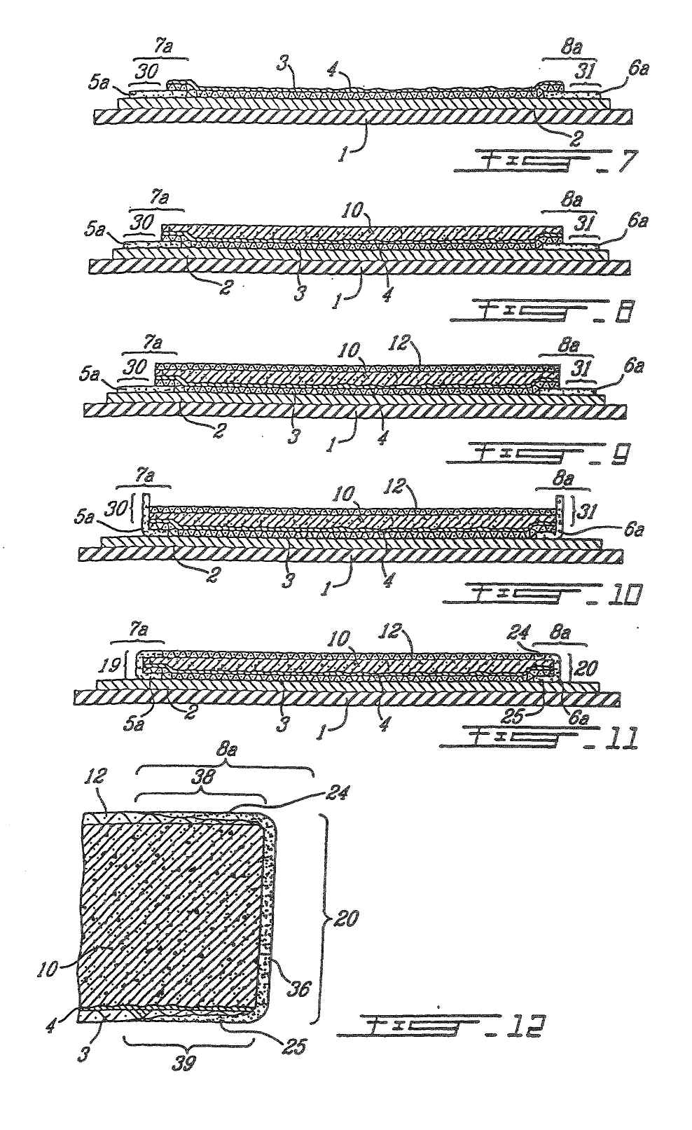

In FIG. 3 a second non-woven basalt fiber mesh 12 is shown as having been laid upon the upper surface of the core mix 10 across the breadth thereof. This second non-woven basalt fiber mesh 12 was laid down under the urging or influence of a vibrating urging means which urged the second non-woven basalt fiber mesh 12 into the upper surface of the core mix, i.e., so as to embed the second non-woven basalt fiber mesh 12 in the top surface of the core mix 10.

In FIG. 3 an additional pair of second bands of polypropylene non-oriented mesh 14 and 15 are also shown in the process of being laid upon the second non-woven basalt fiber mesh 12 in respective margin sections 7 and 8 opposite the previously laid down first bands 5 and 6. These second bands 14 and 15 are likewise laid down under the urging or influence of the vibrating urging means which urges these bands into the upper surface of the core mix on top of the second non-woven basalt fiber mesh 12. The bottom of the core mix 10 is bonded to the mesh 3 by the slurry 4.

In this manner an edge reinforced panel is formed as shown in FIG. 4. The edge reinforced panel has a pair of opposed longitudinal edge faces 19 and 20. Each of the marginal sections 7 and 8 has a pair of marginal areas namely areas 22 and 23 and 24 and 25 which are associated with respective major surfaces of the panel.

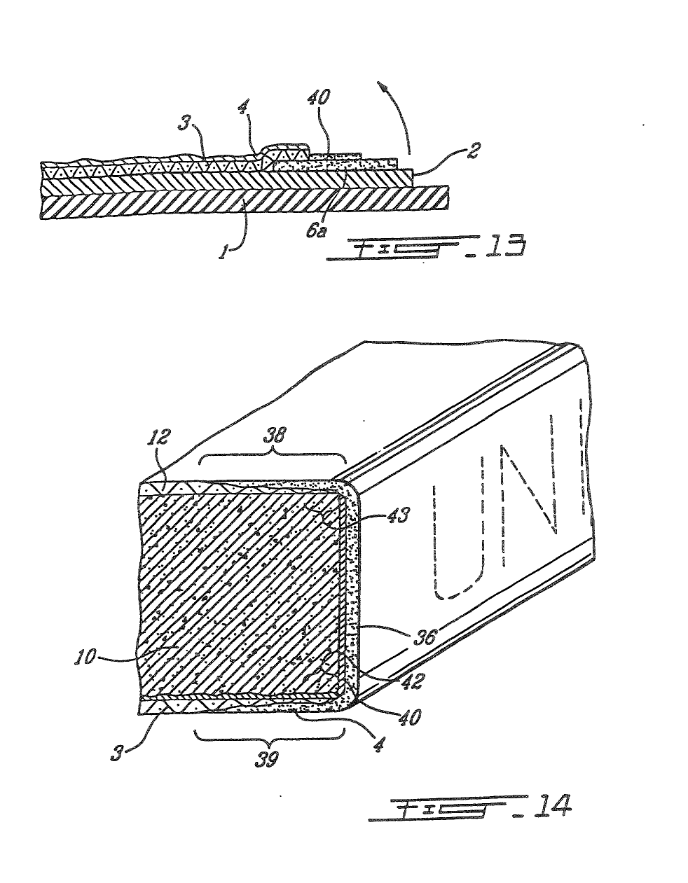

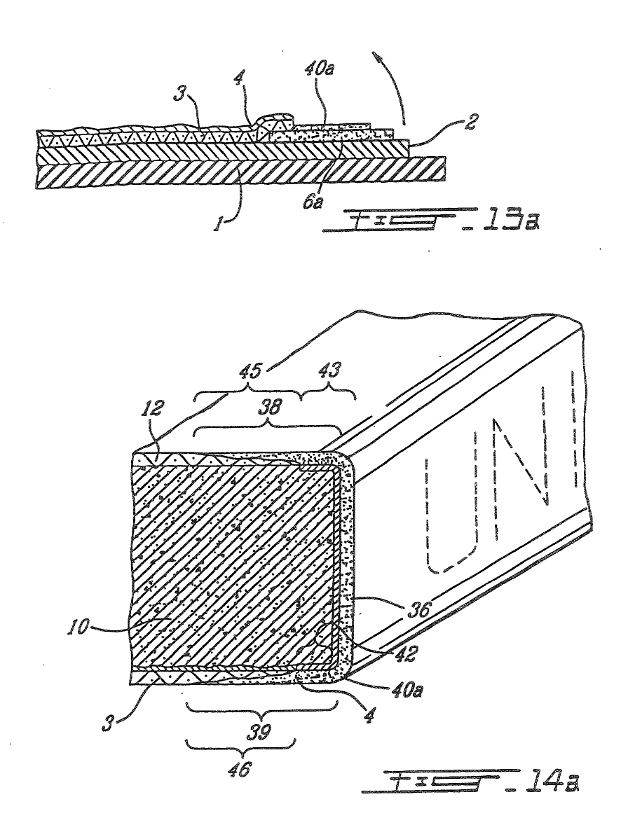

FIG. 5 shows a schematic partial cross-sectional view of a reinforced edge of a panel made in accordance with the steps illustrated in FIGS. 1 to 4. It shows, for example, the longitudinal edge face 20 as not being closed off by, for example, a mesh bridging member connecting respective first and second bands as discussed with respect to the FIGS. 7 to 12. In this case as may be appreciated the longitudinal edge faces of the core are exposed. As may be appreciated from FIG. 5 a longitudinal edge face 20 and a respective pair of marginal areas 24 and 25 defines a longitudinal marginal edge; similarly for the other opposed side of the panel.

FIG. 6 shows a schematic partial cross-sectional view of a reinforced edge of a further panel made in accordance with the steps illustrated in FIGS. 1 to 4 except that the first bands have been omitted such that the panel only has edge reinforcements due to the second bands; accordingly the same reference numerals have been used to designate common elements. It too shows the longitudinal edge face 20 as not being closed off by, for example, a mesh bridging member such that the longitudinal edge faces of the core are exposed.

FIGS. 7 to 11 illustrate in a series of cross-sectional views a sequence of steps in a method for the manufacture of another example edge reinforced panel in accordance with the present invention wherein the longitudinal edge faces are closed off. In these figures the same reference numerals are used to designate elements common with those shown in FIGS. 1 to 6.

In FIG. 7 a web of a first non-woven oriented glass mesh 3 is shown with a previously applied portland cement slurry 4 deposited thereon across its breadth in a layer. The first non-woven oriented basalt fiber mesh 3 has also previously been laid on the protective film 2 such that it overlaps a pair of wide bands 5a and 6a of polypropylene non-oriented mesh which were previously laid on the protective film 2 in parallel spaced apart relationship. The wide bands 5a and 6a are disposed along margin sections 7a and 8a and are only partially covered by the first non-woven oriented glass mesh 3. As may be seen, the margin sections 7a and 8a are only partially covered by the first non-woven basalt fiber mesh 3 and by the slurry 4 such that while the first non-woven basalt fiber mesh 3 is totally slurried, the wide bands 5a and 6a are only partially slurried, i.e., outer portions 30 and 31 of the bands 5a and 6a are left unslurried. On the other hand, if so desired the slurry may be disposed so as not to cover at all the wide bands 5a and 6a.

In FIG. 8 a core mix 10 is shown as having been laid upon the slurried first non-woven basalt fiber mesh 3 so as to be deposited across the breadth thereof in a layer so as to again leave uncovered outer portions 30 and 31. Alternatively, if so desired, the slurry 4 may extend outwardly further over the wide bands 5a and 6a than the core mix 10 or vice versa. The slurry 4 may, for example, be extended outwardly further than the core mix in order to facilitate adherence (e.g., cementing) of the bands to the longitudinal edge face of the panel core or even the opposed broad face at a respective longitudinal marginal edge.

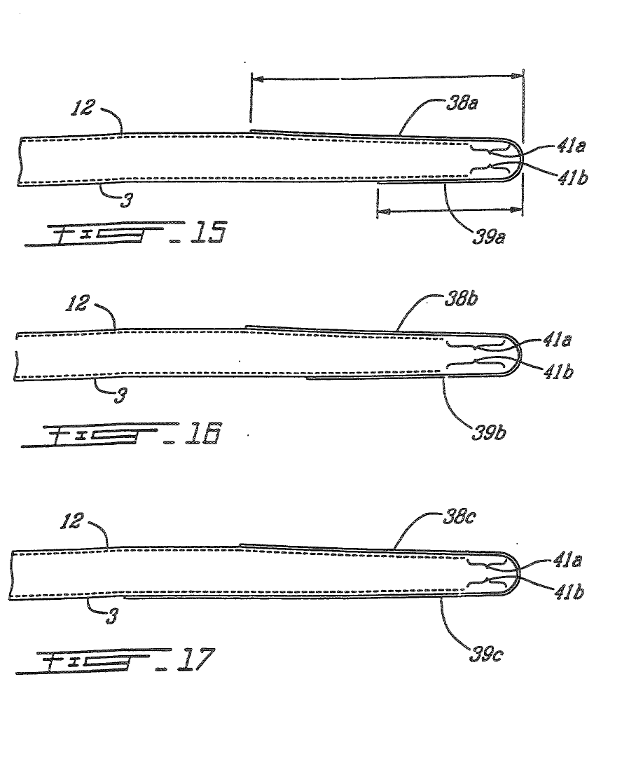

In FIG. 9 a second non-woven basalt fiber mesh 12 is shown as having been laid upon the upper surface of the core mix 10 across the breadth thereof, again so as to leave uncovered outer portions 30 and 31. This second non-woven basalt fiber mesh as before is laid down under the urging or influence of a vibrating urging means so as to embed the second non-woven basalt fiber mesh 12 in the top surface of the core mix 10.

In FIG. 10 the two outer portions 30 and 31 of the wide bands 5a and 6a are folded upwards to an upright position by suitable guide means.

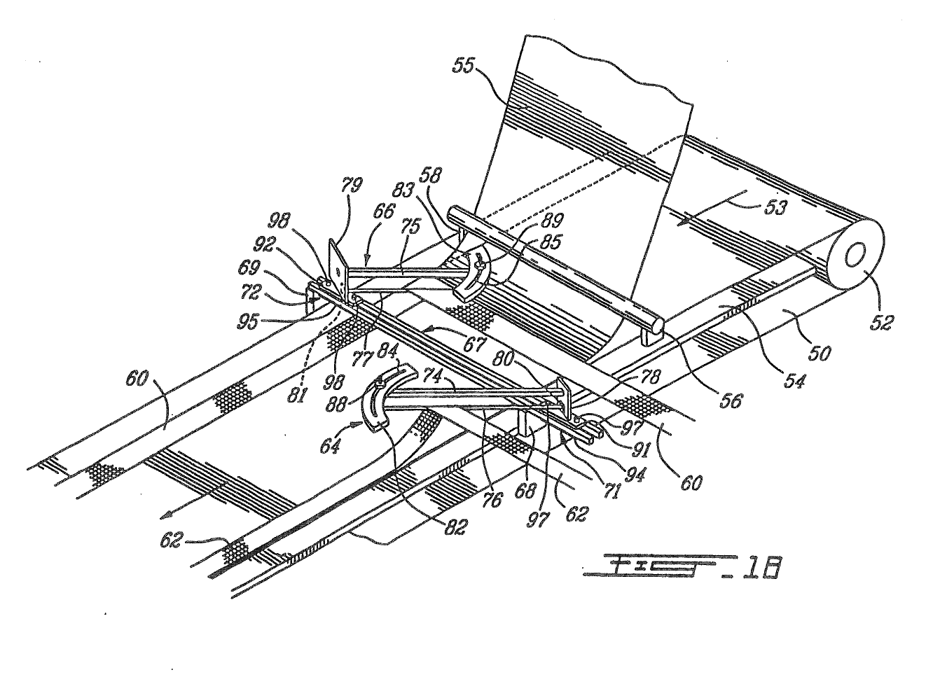

In FIG. 11 the outer portions 30 and 31 are bent or folded by suitable means over onto the second basalt fiber mesh 12 in respective margin sections 7a and 8a so as to form respective U-shaped edge reinforcing meshes adhered to the first and second basalt fiber meshes 3 and 12. The bent over outer portions 30 and 31 are likewise laid down under the urging or influence of the vibrating urging means which urges the distal ends thereof into the upper surface of the core mix on top of the second non-woven basalt fiber mesh 12.

In this manner an edge reinforced panel is formed as shown in FIG. 11. The edge reinforced panel has a pair of opposed longitudinal edge faces 19 and 20. Each of the marginal sections 7 and 8 has a pair of marginal areas namely areas 22 and 23 and 24 and 25 which are associated with respective broad faces of the panel.

FIG. 12 shows a schematic partial cross-sectional view of a reinforced edge of a panel made in accordance with the steps illustrated in FIGS. 7 to 11. It shows, for example, the longitudinal edge face 20 as being closed off by a mesh bridging member 36 of the U-shaped edge reinforcing mesh; this bridging member 36 connects respective first and second edge strip members 38 and 39. In this case, as may be appreciated, the bridging member may be adhered to the core mix due to infiltration of cementitious material into or through the structure of the bridging member. Also as may be appreciated from FIG. 12 a longitudinal edge face 20 and a respective pair of marginal areas 24 and 25 defines a longitudinal marginal edge; similarly for the other opposed side of the panel.

As mentioned above, an edge reinforced panel in accordance with the present invention may comprise a U-shaped edge reinforcing mesh wherein a bridging member need not be adhered to a respective longitudinal edge face but may merely abut such face or as desired be spaced apart therefrom; in this case the bridging member may, for example, be provided with a water impervious character such that cementitious material from the slurry of the core mix may not pass into or through the bridging member during the manufacture of a panel. It is possible, for example, to provide a wide band such as bands 5a and 6a with a centrally disposed at least substantially water impervious longitudinally extending zone on the core side thereof. The zone may provide means of any mechanism which may render the central zone impervious, e.g., by applying a water tight tape, by applying a suitable paint, by applying a wax material, or the like, to the central zone. In such case it is possible, for example, to apply to the opposite exposed side of the bridging member a desired indica in the form, for example, of a color, words, etc. Suitable materials are as follows: adhering tape, masking tape, shipping tape, electrical tape or other self-adhering tape, size: 0.5 to 4 inches wide, preferably 1.5″ wide; made preferably of an impervious polymeric sheet material or film, such as polyethylene but can also be made of other impervious or semi-impervious material.

Material coatings: acrylic paint, oil paint, varnish, wax, silicon sealant, applied with roller or spray equipment on a width from 0.5 to 4 inches wide, preferably 1.5″ wide. The coating can be impervious or semi-impervious. Material: non-adhering film: 1 to 5 mils thick; 0.5 to 4 inches wide, preferably 1.5″ wide; made preferably of: polypropylene, polyethylene, paper, but can also be made of other impervious or semi-impervious material.

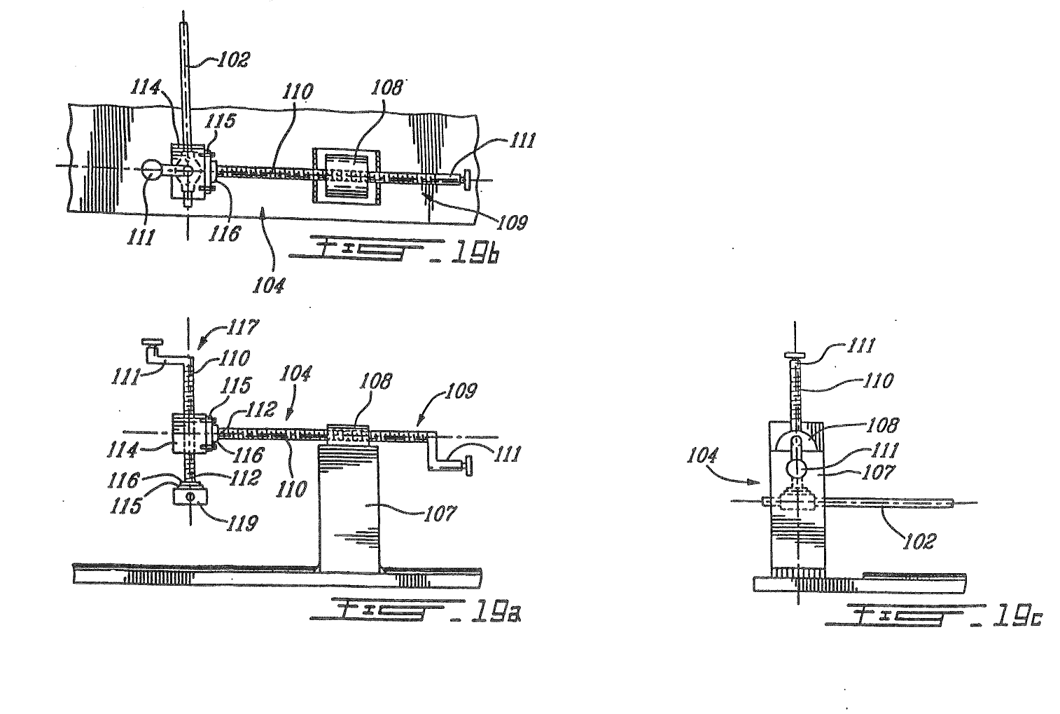

FIG. 13 shows a schematic partial cross-sectional view similar to FIG. 7 but wherein the wide band 6a is provided with a central longitudinally extending, at least substantially water pervious zone defined by an at least substantially waterproof tape 40 which is attached (e.g., glued) to the core side of the band 6a. A similar waterproof tape may, if desired, also be applied to wide tape 5a. As far as the rest of the process as illustrated in FIGS. 7 to 11 are concerned, they stay the same.

FIG. 14 shows a schematic partial cross-sectional view of a reinforced edge of a further panel made in accordance with a process as shown in FIGS. 7 to 11 but with the modification shown in FIG. 13. As may be seen, the panel differs from the panel illustrated in FIG. 12 in that the waterproof tape 40 abuts the longitudinal side edge of the core and is sandwiched between the core side edge face and the bridge member 36. The presence of the tape 40 during manufacture inhibits the bridge member from being adhered to the core, by way of cementation or embedding. Since the tape is at least substantially waterproof, the outer exposed surface of the bridging member, is not covered with cementitious material and the lettering is exposed to view in the final panel product.

As may be seen from FIG. 14, the tape 40 more or less extends only across the breadth of the core side edge face. Alternatively, as desired or as necessary, a substantially water-impervious tape may extend into one or both of the adjacent marginal areas of the broad faces. As mentioned above, a marginal area may have a grip region and an adhesion-free region. Referring back to FIG. 14, examples of the position of such adhesive-free regions are designated by the reference numerals 42 and 43; the grip regions occupy the rest of the marginal areas. If a panel is to have one or both adhesion-free regions 42 and 43, then the above-mentioned process for manufacturing described with respect to FIGS. 13 and 14 may, for example, be modified by using a wider water-impervious tape. FIGS. 13a and 14a relate to such a process for the provision of a panel having such adhesion-free zones along both side edges thereof; in FIGS. 13a and 14a the same reference numerals have been used as with respect to FIGS. 13 and 14 to designate common elements. In FIG. 13a the wider water-impervious tape is designated by the reference numeral 40a. As may be seen from FIG. 14a, the tape 40a in the final panel configuration has a U-shape like cross-section (if somewhat flattened), i.e., a U-shape surface including the surface of the longitudinal or side edge is not adhered to the U-shaped reinforcement mesh component, distal end portions only of the strip members are adhered to the marginal edge faces in the grip regions. For the configuration shown in FIG. 14a the distal part of the strip members is adhered to the core in the grip regions 45 and 46.

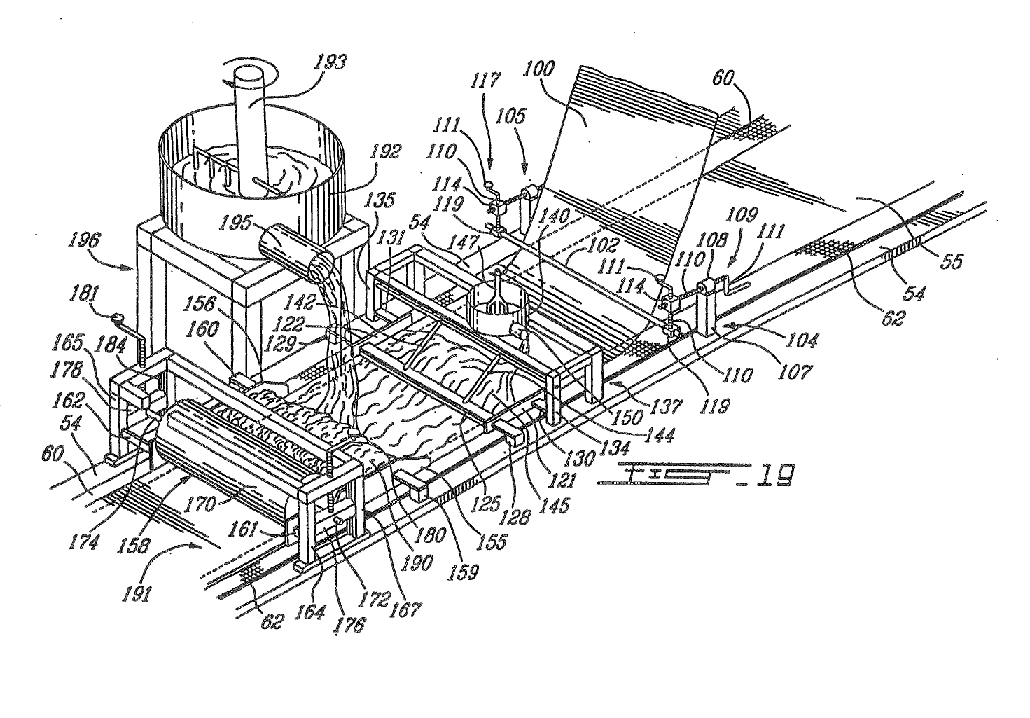

In FIGS. 7 to 14a the first and second edge strip members 38 and 39 are more or less of equal length. In accordance with the present invention these strip members may as desired or necessary be of different length. The FIGS. 15 to 17 show schematic partial views of example panels in accordance with the present invention wherein the strip members are of different length. FIG. 15 shows a strip member 38a which is longer than strip member 39a; FIG. 16 shows a strip member 38b which is somewhat longer than strip member 39b; FIG. 17 shows a strip member 38c which is shorter than strip member 39c.

For purposes of illustration FIGS. 7 to 13 and 14 relate to panels wherein the reinforcement mesh for the broad faces more or less extend the full breadth of the broad face of a panel. However, in accordance with the present invention it is advantageous to have panels wherein the side edges of the basalt fiber reinforcing mesh for the major surfaces do not extend the full breadth of the major surface of a panel but are somewhat offset from the panel edge such as may be seen in FIGS. 15, 16 and 17. The offset distance may, for example, be from ⅛ to ¼ of an inch. Other offset distance may also be used keeping in mind, however, that the edge reinforcement meshes still overlap the edges of the major surface basalt fiber reinforcing meshes in the marginal areas of the major surfaces. The offset regions are designated by the reference numerals 41a and 41b in FIGS. 15 to 16. In order to accommodate such offset regions the process steps discussed above with respect to FIGS. 7 to 13 and 14 may be modified, for example, by using basalt fiber major surface reinforcing meshes which are still centered in place as shown in these figures but for which the width at each side edge is shorter by the above-mentioned amounts (i.e., shortened by from ⅛ to ¼ of an inch); in this case the core mix would be laid down so as to extend beyond the broad mesh edges, for example, by the above-mentioned offset distances.

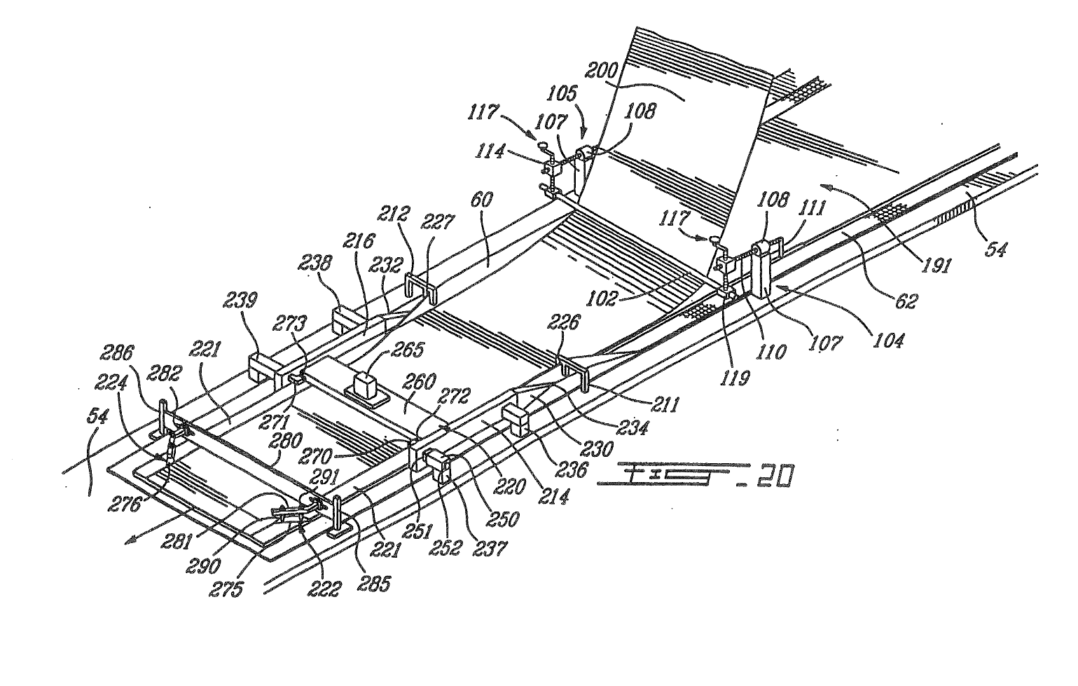

Turning now to FIGS. 18 to 21, these figures illustrate an apparatus for the preparation of an example panel in accordance with the present invention exploiting an example method of manufacture also in accordance with the present invention.

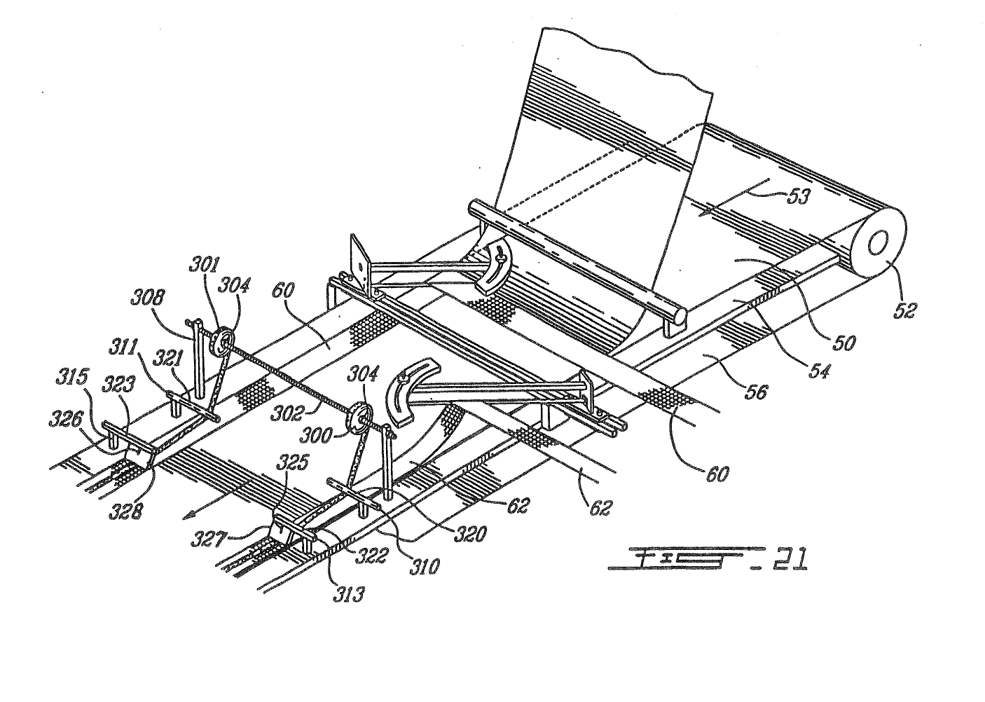

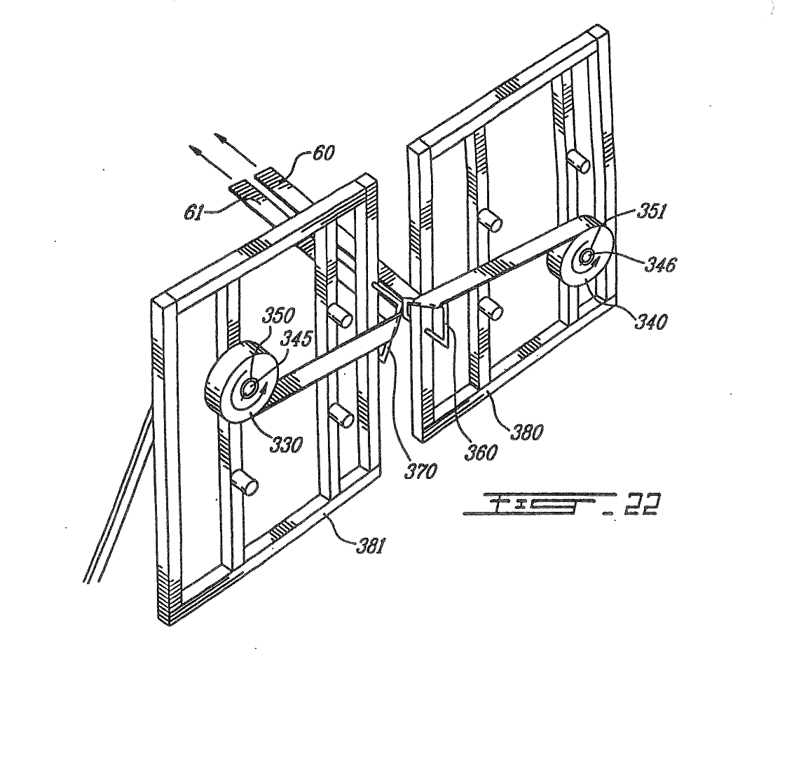

FIG. 18 illustrates an upstream portion of the example apparatus; FIG. 19 illustrates a central portion of the example apparatus; FIG. 20 illustrates a downstream portion of the example apparatus; FIG. 21 illustrates an alternate upstream portion of the example apparatus which is similar to that shown in FIG. 18 but which includes a tape application zone; and FIG. 22 illustrates an upstream band feeding station for feeding a pair of side reinforcement band meshes to the apparatus upstream portion shown in FIG. 18.

Referring to FIG. 18, the apparatus has a conveyor system comprising an endless conveyor belt 50 as well as attendant drive and return rollers; return roller 52 is shown in FIG. 18; the drive roller (not shown) is located at the other end of the conveyor belt and is configured in any suitable manner so as to be able to induce movement of the belt such that it travels in a working direction as shown by the arrow. The apparatus also has a support or forming table 54. The conveyor system and the table 54 are arranged such that the conveyor belt 50 is able to slightly travel over the surface of the table 54 such that the table is able to support the conveyor belt as well as any material disposed thereon.

The apparatus includes a protective film alignment component for alignment of a protective film 55 onto the conveyor belt. The protective film 55 is fed from a roll of such film (not shown). A protective film 55 is laid onto the belt so as to protect it and avoid the necessity of applying a release agent thereto. The film 55 should be wider than the board's width, for example, wider by at least 5″ to 7″ or more. The protective film 55 may, for example, be made of polyethylene 3.0 to 5.0 mils in thickness.

The protective film alignment component comprises an alignment bar 56 as well as support members 57 and 58 which maintain the alignment bar 56 a predetermined distance above the conveyor belt 50. The alignment bar 56 is suitably fixed to the support members 57 and 58 (e.g., as by welding, bolting, etc.); the support members 57 and 58 are similarly fixed to the table 54.

Further downstream the apparatus has a side edge reinforcement deposit station for depositing a pair of spaced apart bands 60 and 62 of reinforcement mesh onto the protective film. The side edge reinforcement deposit station has pair of edge band alignment components 64 and 66 which are releasably slidable along a transverse rail element 67 fixed to side edges of the table by upright support members 68 and 69 such that the rail element 67 is suitably spaced above the conveyor belt. The rail element comprises two parallel spaced apart tracks. These band alignment components are configured so as to be positioned for depositing, onto the protective film, the two parallel bands 60 and 62 of reinforcement mesh in the appropriate marginal positions according to a panel's or board's desired width. The bands 60 and 62 may be of sufficient width (e.g., 4″ to 5″) so as to cover the upper and lower marginal edge areas (2″ to 3″ wide) and provide a 1″ minimum overlap of the upper and lower broad face reinforcement meshes referred to below.

The bands 60 and 62 of reinforcement mesh may, for example, be made of a synthetic non-woven non-oriented water-impervious material such as polypropylene, or basalt fiber woven or non-woven fabric. These bands 60 and 62 may, for example, have a thickness of 0.010″ and 0.020″ and a density of 2 to 4 ounces per square yard. The bands 60 and 62 may, for example, be in the form of a roll of a diameter of 20″ to 50″ but preferably 30″, e.g., in order to give a length of 500 to 1000 linear yards.

The band alignment components 64 and 66 each have a rail grip member, respectively, designated by the reference numbers 71 and 72 for releasably gripping the rail element 67 so as to releasably attach these components to the rail element 67 at a predetermined position thereon. Each band alignment component 64 and 66 comprises an upper support arm (respectively designated by the reference numbers 74 and 75) and a lower slide bar arm (respectively designated by the reference numbers 76 and 77) which are attached to an upright support plate (respectively designated by the reference numbers 78 and 79) which projects from each of the rail grip members 71 and 72 transversely to the longitudinal axis of the rail element 67. The upper support arms 74 and 75 project more or less at a right angle from a respective plate 78 or 79 to which they are fixed in any suitable fashion (e.g., by welding). The lower slide bar arms 76 and 77 are respectively pivotally attached to plate 78 and 79 by any suitable pivot means 80 and 81 (e.g., a hinge). The band alignment components each respectively have a crescent plate 82 and 83 fixed at the distal ends of upper support arms 74 and 75; these crescent plates 82 and 83 are each provided with an arc shaped alignment slot 84 or 85. The distal end of each of the lower slide bar arms 76 and 77, respectively, has an upturned threaded end portion which extends upwardly at right angles to the rest of the slide bar arm through a respective slot 84 and 85. A respective tightening nut 88 or 89 is disposed on a respective threaded end portion above a respective plate 82 or 83. Just adjacent the underside of each plate 82 and 83 a respective upper end portion has a respective transversely projecting ridge member disposed such that as a respective nut 88 or 89 is screwed downwardly the ridge member can abut the underside of a respective plate 82 or 83 so as to clamp a respective lower slide bar arm 76 or 77 at a predetermined arc position.

Loosening the nuts 88 or 89 allows the lower slide arm bar 76 or 77 to be pivoted about the pivot means 80 or 81 to a desired arc position.

Each of the rail grip members 71 and 72 is also configured so as to be able to releasably clamp a respective band alignment component 64 or 66 at a predetermined position on the rail element 67. The grip members 71 and 72 each have upper clamp plates (respectively designated by the reference numbers 91 and 92), lower clamp plates (respectively designated by the reference numbers 94 and 95) and a pair of releasable tightening bolts (respectively designated by the reference numbers 97 and 98). The upper clamp plates 91 and 92 are provided with unthreaded openings through which the shafts of the bolts 97 and 98 project. On the other hand the lower clamp plates 94 and 95 are provided with threaded openings which are able to engage the corresponding thread of the shafts of the bolts 97 and 98 passing thereinto through the slot between the tracks of the rail element 67. As may be understood, rotation of the bolts 97 or 98 in one direction will tend to tighten a respective clamp plate to the rail element 67 for fixing a respective alignment component 64 or 66 to the rail element 67 while rotation in the opposite direction will tend to loosen the grip of the clamp plates on the rail element 67 so that the alignment component 64 or 66 may be displaced as desired along the rail. The position of the slide bar arms 76 and 77 is thus adjustable.

As is shown in FIG. 18, both slide bar arms 76 and 77 are able to be maintained at an angle of 45 degrees with respect to the direction of travel of the conveyor belt such that the bands 60 and 62 being fed thereto at an angle more or less perpendicular to the direction of travel of the conveyor belt 50 are able to change direction and be deposited in parallel spaced relationship onto the protective film 55. The adjustability of the band alignment components 64 and 66 means that they can also be moved to different positions in order to produce panels of different width (e.g., panels having a width of 32″, 36″ or 48″ wide boards).

The bands 60 and 62 may, for example, be aligned so that their edges are not outside of the edges of the protective film 55. The distance between the outer edges of the bands 60 and 62 and the outer edges of the protective film 55 may, for example, be from 0″ to 0.5″.

Referring now to FIG. 19 the apparatus has a first broad face reinforcement deposit station for depositing a bottom or lower basalt fiber layer onto the protective film 55 and the bands 60 and 62. The first basalt fiber, major surface reinforcement deposit station has a first mesh layer alignment component for depositing the bottom or lower layer of basalt fiber reinforcement mesh 100 onto the protective film 55 so as to overlap portions of each of the above-mentioned side edge reinforcement bands 60 and 62. For the present example apparatus the lower layer of the basalt fiber reinforcement mesh 100 is sized and centered so that the distance between the outer edges of the basalt fiber reinforcement mesh 100 and respective outer edges of the reinforcement bands 60 and 62 are more or less the same.

The first mesh layer alignment component comprises an alignment bar 102 as well as support members 104 and 105 which maintain the alignment bar 102 a predetermined desired distance above the conveyor belt 50. The support members 104 and 105 may be adjustable or non-adjustable as desired or necessary.

In FIG. 19 the support members are shown as being adjustable such that the alignment bar may be displaced upwardly and downwardly as well as forwardly in the direction of travel of the conveyor belt and backwards in the opposite direction. The following description will be given with respect to support member 104 but the same reference numbers will be used to designate the common elements of support element 105.

Referring to FIGS. 19, 19a, 19b and 19c the support member 104 has an upright support element 107 provided at the top thereof with a crown element 108 fixed thereto having a threaded channel. The support member 104 has a first crank 109 provided with a threaded shaft 110, a crank handle 111 at one end and at the other distal end an abutment head 112. The threaded shaft 110 is in screw engagement with the threaded channel of the crown element 108. The abutment head 112 is rotatably attached to a further crank body by fixing the outer shell 115 of a bearing member to the crank body 114 and fixing the inner bearing element 116 which is rotatable with respect to the outer shell 115, to the abutment head 112. In this way rotation of the crank 109 in one direction will cause the head 112 to rotate and push against the crank body 114 while rotation in the opposite direction will cause the head 112 to pull the crank body 114. The support member 104 includes an additional or second crank 117 which is connected in analogous fashion to the crank body 114 and an alignment bar attachment member 119 which in turn is attached to the alignment bar 102 such that rotation of the crank 115 through the crank body 114 either induces the bar 102 to be raised or to be lowered. With respect to the second crank 117, the same reference numbers are used to designate elements which are common with the first crank 109.

FIGS. 19a, 19b and 19c show in detail the above-described dual crank system for the support member 104.

The apparatus has a slurry station comprising a pair of slurry edger rail elements 121 and 122, a slurry scrapper or screed bar element 125 and a slurry delivery system. The purpose of the slurry station is to facilitate adherence of the basalt fiber reinforcement mesh 100 to the core mix by first embedding the mesh 100 in a slurry layer prior to the deposit of the core mix thereon; this slurry layer will also serve to create a smooth side face for the panel. However, if desired, this slurry station may be omitted.

The slurry edger rail elements 121 and 122 are directly attached to the table 54 by connector elements 128 and 129 and indirectly by elements 130 and 131 attached to legs 134 and 135 of a support structure 137 for supporting a slurry holding container 140. The edger rail elements 121 and 122 are fixed in place such that the lower edge of each of the edger rail elements 121 and 122 is spaced apart from the table 54 a distance sufficient to allow the conveyor belt 50, protective film 55 and any desired layer or layers of reinforcing mesh to pass between. This distance however is such that the slurry deposited on the lower mesh 100 is inhibited from spreading laterally beyond these edger rail elements 121 and 122. The edger rail elements 121 and 122 are also spaced apart a desired predetermined distance so as to assure that a predetermined constant width of slurry is deposited on the lower mesh 100.

The slurry scrapper or screed bar element 125 is attached to the support structure 137 for the slurry holding container 140 by support arms 142 and 144 such that the lower edge of the screed bar element 125 is spaced apart from the table 54 so as to define a screed distance (i.e., a nip) sufficient to allow the conveyor 50, a protective film 55 and any desired layer or layers of basalt fiber reinforcing mesh to pass therebetween. This screed distance however is such that the slurry deposited on the lower basalt fiber mesh 100 and which passes under the screed bar element 125 forms a slurry layer of predetermined depth in which the lower basalt fiber mesh 100 is embedded. The screed bar element 125 may be of rubber.

As may be appreciated, the slurry edger rail elements 121 and 122 and the slurry scrapper or screed bar element 125 form a type of U-shaped raised barrier dam structure having lower edges which are spaced apart from the table sufficient above-described respective spacing distances. By suitable manipulation and synchronization of the speed of the conveyor belt 50 and the flow rate of slurry onto the lower basalt fiber mesh 100 more or less at the mouth of the dame, slurry suitably deposited on the lower basalt fiber mesh 100 may be made to backflow and create an upstream slurry pool 145 within the U-shaped barrier dam which may be generally deeper than these spacing distances. In this manner a slurry layer may be continuously laid down in which the lower basalt fiber mesh 100 is embedded.

The slurry delivery system comprises the slurry holding container 140, an agitator 147 and a controllable slurry outlet member indicated generally by the reference number 150. The slurry holding container 140 is supported by the support structure 137, the container 140 being attached to the support structure 137 in any suitable fashion, e.g., bolting. The agitator is connected to a motor (not shown) for rotation of the agitator. The components of the slurry may be mixed together in a separate container (not shown) and thereafter be delivered to the slurry holding container 140 in any suitable fashion (e.g., through appropriate ducting or manually); once in the slurry holding container 140 the agitator functions to maintain the slurry in a more or less homogeneous mixed state prior to its being released onto the lower mesh 100. Alternatively, if desired or as necessary the slurry components may be delivered in any suitable fashion directly to the slurry holding tank 140 where they may be mixed due to the influence of the rotating agitator 147. The controllable slurry outlet member 150 may include a valve (not shown), such as a gate valve, which may be (spring) biased in a closed position. The valve may be connected to a solenoid type means whereby in response to an electrical signal the valve may be opened so as to release slurry onto the lower mesh 100 at time intervals synchronized with the movement of the lower mesh 100 thereunder. The outlet member 147 is disposed such that the slurry deposited on the lower mesh 100 may be maintained within the confines of the above described U-shaped barrier dam and form the above-mentioned slurry pool 145.

The apparatus also has a core mix station which is similar in general makeup to the slurry station. The core mix station comprises a pair of core mix edger rail elements 155 and 156, a core mix screeding roller component 158 and a core mix delivery system. The purpose of the core mix station is to deposit core mix onto the slurried lower mesh 100 so as to form a core mix layer covering the breadth of the lower mesh.

The core edger rail elements 156 and 157 are directly attached to the table 54 by connector elements 159 and 160 and indirectly by elements 161 and 162 attached to legs 164 and 165 of a support structure 167 for supporting a screed roller 170 such that the lower edge of each of the rail elements 156 and 157 is spaced apart from the table 54 a distance sufficient to allow the conveyor 50, protective film 55 and any desired layer or layers of reinforcing mesh to pass therebetween. This distance however is such that the core mix deposited on the slurried lower mesh is inhibited from spreading laterally beyond these edger rail elements 156 and 157. The edger rail elements 156 and 157 are also spaced apart a desired predetermined distance so as to assure that a constant width of core mix is deposited on a slurried lower mesh. The core edger rail elements 156 and 157 may be of high molecular weight polyethylene.

The core mix screeding roller component comprises a screed roller 170 and the support structure 167 for holding the roller 170 in place. The roller 170 may have a (poly)urethane covered surface. The roller 170 has shaft elements 172 and 174 fixed at opposed ends thereof. These shaft elements 172 and 174 are each engaged in respective bearing means (not shown) provided in the cross members 176 and 178; these bearing members allow the screed roller 170 to be rotated about a longitudinal axis. The shaft 172 is attached to a motor (not shown) for urging the clockwise rotation of the screed roller 170; the motor is suitably configured, for example, to rotate the screed roller 170 clockwise in the same direction as the conveyor belt 50 but at a speed slower than the speed of the conveyor belt 50.

The screed roller 170 may be fixed in place or be vertically adjustable as to vary the nip between the roller and the conveyor belt. In FIG. 19 the screed roller is illustrated as being vertically adjustable.

The cross members are vertically displaceable by a crank system analogous to that shown in FIGS. 19a, 19b and 19c such that the screed roller 170 may be displaced up and down so that the nip between the roller 170 and the conveyor belt 50 may be set to the desired core mix layer thickness. The crank system includes a single crank component (the cranks being designated by the reference numbers 180 and 181). The side ends of the cross members 176 and 178 are each provided with key elements slidably engaged in slots on the inside parts of the roller support structure 167; one of the slots is designated with the reference number 184.

As may be appreciated, the screed roller 170 and core mix edger rail elements 155 and 156 also form a type of U-shaped raised barrier core mix dam structure having lower edges which are spaced apart from the table 54 sufficient above described respective spacing distances. By suitable manipulation and synchronization of the speed of the conveyor belt 50 and the flow rate of core mix onto the lower mesh more or less at the mouth of this core mix dam, core mix suitably deposited on a lower mesh may be made to backflow and create an upstream core mix mass 190 within the U-shaped barrier dam which may be generally deeper than these spacing distances, (i.e., in particular, deeper than the screed roller nip). In this manner a core mix layer 191 may be continuously laid down over the slurried lower mesh.

The core mix delivery system comprises the core mix holding container 192, an agitator 193 and a controllable core mix outlet member indicated generally by the reference number 195. The core mix holding container 192 is supported by the support structure 196. The agitator 193 is connected to a motor (not shown) for rotation of the agitator. The components of the core mix may be the same as for the slurry but including aggregate and if desired an air entraining agent or other desired or necessary components. The components of the core mix may be mixed together in a separate container (not shown) and thereafter be delivered to the core mix holding container 192 in any suitable fashion (e.g., through appropriate ducting or manually); once in the core mix holding container 192 the agitator functions to maintain the core mix in a more or less homogeneous mixed state prior to its being released onto the slurried lower mesh. Alternatively, if desired or as necessary the core mix components may be delivered in any suitable fashion directly to the core mix holding tank 192 where they may be mixed due to the influence of the rotating agitator. The controllable core mix outlet member 195 may include a motorized archimedes screw for delivering core mix onto the slurried lower mesh at timed intervals synchronized with the movement of the slurried lower mesh thereunder; the rotation of the screw may, for example, be controlled by a timer mechanism which controls the energization and denergization of the screw motor. The outlet member 195 is disposed such that the core mix deposited on the slurried lower mesh may be maintained within the confines of the above-described U-shaped barrier core mix dam and form the above-mentioned core mix mass.

Turning to FIG. 20 the apparatus has a second broad face reinforcement deposit station for depositing a bottom or lower mesh layer onto the core mix layer.

The second broad face reinforcement deposit station has a layer alignment component for depositing a top or upper layer of basalt fiber reinforcing mesh 200 onto the core mix. For the present example apparatus the top layer of the basalt fiber reinforcement mesh 200 is sized and centered so that the distance between the outer edges of the top basalt fiber reinforcement mesh 200 and outer edges of the reinforcement bands 60 and 62 are more or less the same as that for the lower layer of basalt fiber reinforcement mesh 100.

The top or upper basalt fiber mesh layer alignment component comprises the same type of elements as the above-described lower basalt fiber mesh layer alignment component so the same reference numerals designated the common components. Essentially the top or upper basalt fiber mesh layer alignment component comprises an alignment bar 102 as well as a dual crank system as described above for adjusting the position of the bar 102.

Still referring to FIG. 20 the apparatus has a finishing station. The finishing station comprises a pair of guide fork elements 211 and 212, a pair of opposed finishing edge rail elements 214 and 216, a vibratable floatable screed plate member 220 and a pair of edge compression ski components 222 and 224.

The guide fork elements 211 and 212 each comprise gibbet like support members and a prong end having a pair of downwardly extending prongs or fingers generally designated by the reference numerals 226 and 227. The gibbet like support members are attached to the table.

The finishing edger rail elements 214 and 216 each have guide flange ends 230 and 232 which taper in the upstream direction such that the inner face tapers towards the outer face thereof and the top face tapers downwardly. The tip ends (one of which is designated with the reference number 234) of the guide flange ends 230 and 232 are each disposed more or less just below the prong end of a respective guide fork element 211 and 212, i.e., just below the gap between the two prongs. The guide fork elements 211 and 212 and the guide flange ends 230 and 234 cooperate to urge marginal mesh regions as well as the marginal regions of the protective film from an initial horizontal position upwardly to a vertically extending position from which distal edges thereof may then be bent inwardly and downwardly under the influence of the vibratable floatable screed plate member 220.

The finishing edger rail elements 214 and 216 are attached to the table by connector elements 236, 237, 238 and 239 such that the lower edge of each of the finishing edger rail elements is spaced apart from the table 54 so as to define a nip sufficient to allow the conveyor belt to pass there. The rail elements are also spaced apart a desired predetermined distance so as to assure that the inner surface thereof may sliding abut respective panel side edges. If desired, the finishing edger rail elements 214 and 216 may be fixed in place by the above-mentioned connector elements. However, if desired, the edger rail elements may be laterally adjustable in order to accommodate panels of different width. For example, the connector elements may have outer shell and an inner telescoping member and an adjustment bolt; these elements by way of illustration are designated with respect to connector 237, respectively, by numbers 250, 251 and 252. The bolt may be suitably attached in any manner to the back of the outer shell so that rotation of the bolt in one direction will induce the edger rail element 214 to move laterally inward while a reverse rotation will induce a laterally outward displacement of the edger rail element 214.

The vibratable floatable screed member 220 comprises an elongated plate 260 and a vibrator 265 (e.g., a compressed air turbine vibrator) for inducing the plate 260 to vibrate up and down. The vibrator is connected to a suitable energization source (not shown). The plate 260 extends between the inner surfaces of the finishing edger rail elements 214 and 216 and is sufficiently long so as to overlap top marginal regions of the top major surface of the panel being made. The vibratable floatable screed member 220 is made of a relatively light weight material so that it is able to essentially float over the upper or top basalt fiber mesh and yet be able to ride over distal parts of the side edge meshes and protective film as the panel passes thereunder, i.e., so as to complete the inward and downward bending of distal edges of the side edge meshes. The plate 260 may, for example, weigh from 20 to 60 pounds, be 3″ to 9″ wide, and be of aluminum. The vibratable floatable screed member 220 is maintained in position against the movement of the panel there underneath by bumper or stop elements 270 and 271 which may have rubberized tips 272 and 273. The vibrator 265 may vibrate the plate 260 so as to induce the upper mesh as well as the bent over edge mesh portions overlapping the upper basalt fiber mesh to become embedded in the upper major surface of the core mix layer.

As mentioned, the protective film and the bands are turned upside down (folded) along the board's edges; the folded over webs are designated by the reference number 221. Advantageously, sufficient distance (for example, 10 to 20 feet) is provided between the screed roller and the vibrating bars such that the band may be folded naturally, releasing the tension that can cause the band to spring out of the board's surface. The finishing edger rail elements may start, for example, from 20 to 5 feet before the vibrating plate. These edger rail elements 214 and 216 help the protective film and the bands to be folded without ripples or uneven tension and inhibit the changing of the board dimensions when subject to the aforementioned under vibrations.

The apparatus has a pair of edge compression ski components 222 and 224 for smoothing out the edge regions and providing the edges with an outward taper (please see FIGS. 15, 16 and 17). The edge compression ski components 222 and 224 each comprise a ski shaped engagement element 275 or 276 for riding an edge of the panel. The ski shaped engagement elements 275 and 276 are fastened to a support bar 280 by respective brackets 281 or 282. The support bar 280 itself is suspended above and fixed to the table 54 on opposite sides of the conveyor belt 50 by upright support elements 285 and 286.

The ski shaped engagement elements 275 and 276 are each attached to respective brackets by a pair of nut/shaft systems. The following will describe one such nut/shaft system in relation to the component 222; the other nut/shaft systems are the same. Referring to component 222 the nut/shaft system comprises a threaded shaft 290 and a pair of nuts; an upper nut being designated by the reference number 291. The threaded shaft 290 is attached at one end to the ski engagement element 275 and the other distal end engages a threaded channel in bracket 281; the distal end of shaft 290 extends through the threaded channel and engages the upper nut 291. The second nut engages the threaded shaft just below the bracket 281. The nuts may be made to releasably clamp the shaft 290 to the bracket 281 by suitable rotation thereof in opposite directions. By displacing the nuts along the shaft the ski engagement element may be made to exert more or less pressure on the adjacent film may be separated and recovered. Thereafter the cut panels may be sent to a stacking/packaging station where the panels may be moist cured for 3 to 7 days before shipping. The end drive roller for the conveyor belt may be located between the curing and cutting stations.

Referring to FIG. 21 this figure is the same as FIG. 18 but it additionally shows an example tape application station for application of an adhesive tape to the core side of the bands 60 and 62 so as to provide a panel in accordance with the present invention wherein the bridging member is not adhered to the core as described above. Since FIG. 21 is, except as noted above, the same as FIG. 18, FIG. 21 will not include all of the reference numbers of FIG. 18.

The tape application station includes a pair of rolls of tapes 300 and 301, a threaded tape support rod 302, a plurality of clamp nuts (each generally designated by the reference number 304), upright support members 306 and 308, tape alignment components 310 and 311, and tape pressure applications components 313 and 315.

The rolls of tape include tape cores through which the tape support rod 302 may be threaded; a tape core is sized such that a roll of tape is freely rotatable about the support rod 302. A roll of tape (300 or 301) is maintained in essentially one predetermined position by being bracketed between adjacent clamp nuts 304. The upright support members 306 and 308 have upper openings through which the threaded rod 302 extends. The rod 302 is similarly maintained in place by clamp nuts 304. The alignment components each include a respective arm 320 and 321 which bring the tape to an initial close proximity to a respective underlying band (60 or 62) such that a subsequent upstream tape pressure application component 313 or 315 may press down on the tape such that the adhesive thereof causes the tape to be adhered to the band. The tape pressure application components 313 and 315 each respectively includes a contact element 327 or 328 hinged at one side to a respective support arm 322 or 323; the contact elements are biased by a respective bias spring 325 or 326 such that the side of the contact element opposite the hinged side thereof is biased so as to slide over the tape urging the tape into adhesive contact with the bank (60 or 62). With the tape in place a panel as discussed with respect to FIGS. 13, 13a, 14 and 14a may be manufactured.

Instead of the above described tape mechanism one could use an analogous paint applicator, wax applicator, etc.

FIG. 22 shows an example mechanism for feeding reinforcing strips or bands 60 and 62 to the apparatus forward end illustrated in FIG. 18. As may be seen, rolls of mesh bands 330 and 340 are rotatably attached to shafts 345 and 346; the attachment may in any suitable fashion so as to be able to let out the bands as necessary. For example, the rolls may have central cores 350 and 351 which may be able to slide over the shafts 345 and 346 in the manner of rotatable sleeves. The rolls may be maintained in place by a block arm releasably screwed to a respective shaft 345 or 346; the block arms inhibiting longitudinal axial movement of the rolls off of the shaft but not rotation movement about is the shaft. The mechanism include 45 degree slide arms 360 and 370 for changing the direction of motion of the bands by 90 degrees as well as a base support structure 380 and 381.

Basalt Fiber Reinforcing Mesh, Scrim or Fabric

The basalt fiber reinforcing component embedded in one or both major surfaces of the cementitious panels or boards of the present invention may be in the form of a non-woven basalt fiber oriented or non-oriented mesh, scrim, fabric or web or tissue; or a woven oriented or non-oriented basalt fiber mesh, scrim, fabric, or web. A non-woven basalt fiber fabric or tissue may be of fibers, filaments, or microfibers and may have a weight of about 1 to 20 ounces per square yard, the fibers may, for example, have a diameter of, e.g., 1 to 20 μm.

The mesh size and the fiber diameter for a woven or non-woven oriented or non-oriented basalt fiber reinforcing component used to reinforce the major surfaces of the core may be selected according to the strength desired in the board and the size of the aggregate in the concrete and/or gypsum core mix. A basalt fiber mesh for reinforcement of one or both major surfaces may, for example, have a relatively loose thread or mesh count per inch (warp x fill) such as for example, of from 4×4 to 18×18, e.g., 10×8, for most purposes.

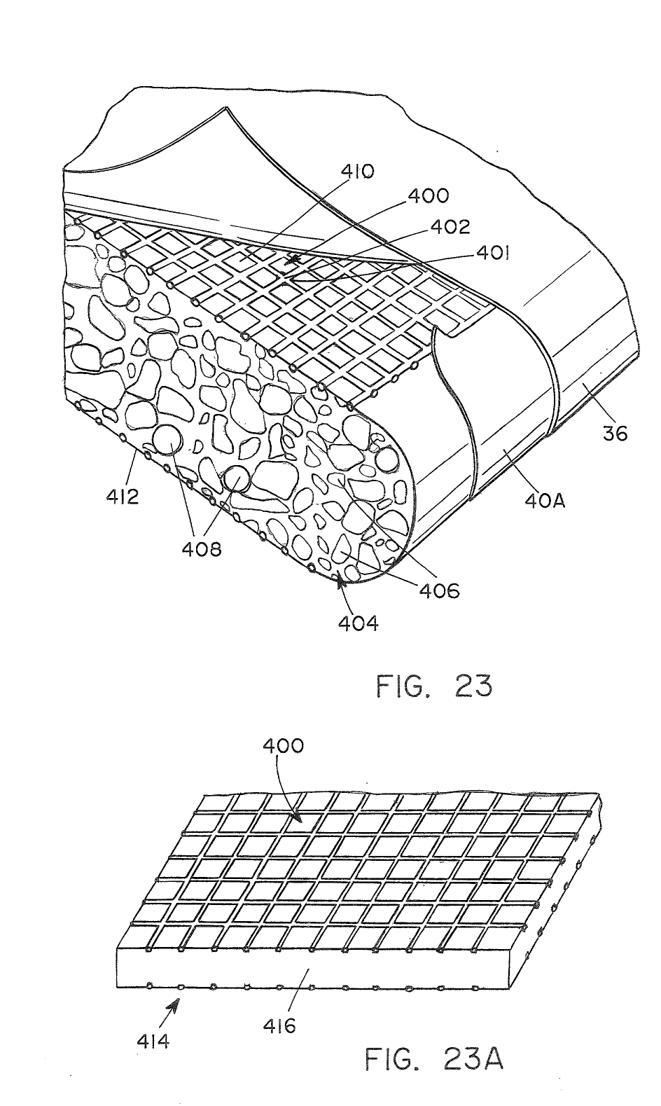

The preferred form for the basalt fiber reinforcing mat is a scrim or mesh 400, as shown in FIGS. 23 and 24. Such mesh or scrim 400 is manufactured, as known in the art of glass scrim manufacture, from looms that lay warp and woof, strands or rovings, of basalt fiber in perpendicular, contacting relationship, and the strands or rovings can then be heat-treated and coated with an adhesive material 401, preferably repeatedly, to secure the warp and woof strands or rovings together at their areas of crossover and contact 402. FIG. 23 shows a preferred embodiment comprising a gypsum cement core material, generally designated 404, containing gypsum and portland cement and further containing aggregate 406 and expanded polystyrene beads 408, reinforced on both the upper major surface 410 and the lower major surface 412 (not shown) with the basalt fiber mesh or scrim 400 embedded in the core material 404. The side edges 414 also are optionally reinforced with a water-impervious, e.g., vinyl polymer, tape 40a and an outer layer of reinforcing material 36, either in the form of a fibrous, non-woven fabric or water-impervious sheet material, such as another layer of vinyl polymer sheet material.

FIG. 23a shows the same basalt fiber reinforcing mesh 400 reinforcing and embedded within both the upper and lower major surfaces of a gypsum panel 414 comprising a gypsum core composition 416.

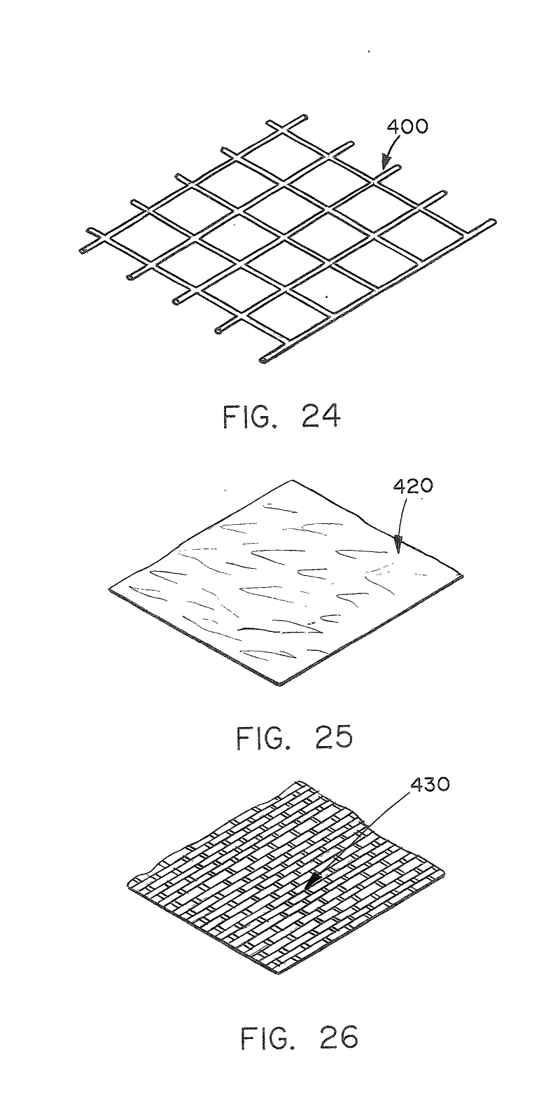

Another suitable form for the basalt fiber reinforcing mat, as shown in FIG. 25, is a non-woven fabric or tissue 420 that can be manufactured by water-laying or air-laying (preferably water-laying) chopped staple fiber having a length of about 12 mm to about 90 mm, preferably about 25 mm to about 40 mm, and a diameter of about 5 mm to about 25 mm, preferably about 8 mm to about 15 mm, e.g., 10 mm. Such a non-woven basalt fiber mat should sufficient porosity to be embedded in a gypsum 416, cement, or gypsum cement core material 404. The non-woven fabrics 420 generally should have a basis weight in the range of about 250 to about 1,500 grams/m² preferably about 600 to about 1,000 grams/m².

A woven fabric 430, as shown in FIG. 26, is suitable as a major surface reinforcing mat for the boards or panels of the present invention. The woven fabrics 430 preferably are woven from basalt fibers having a diameter in the range of about 8 mm to about 10 mm with a fiber count of about 110 picks/inch to about 150 picks/inch. The woven fabric 430 should have sufficient porosity to facilitate embedded mat in a gypsum 416, cement, or gypsum cement core material 404. The woven fabric 430 generally should have a basis weight in the range of about 350 to about 1,500 grams/m², preferably about 600 to about 1,000 grams/m².

Examples of a basalt fiber, major surface reinforcing mesh and a basalt fiber major surface reinforcing mat which may be used herein are as follows:

Mesh

The mesh would contain between 7 to 12 ends per inch in the warp direction, preferably 10.0 ends per inch, and 6 to 9 ends per inch in the fill direction, preferably 8.5 ends per inch. The mesh would have an initial tensile strength between 75 to 125 pounds in the warp direction, preferably 100 pounds, and 60 to 90 pounds in the fill direction, preferably 85 pounds. The mesh would also have a bursting strength between 60 to 100 pounds per square inch, preferably 80 pounds per square inch.

Mat

The basalt fiber mat would contain randomly dispersed chopped fiber strands with a diameter between 8 microns to 12 microns, preferably 9 microns. The basalt mat with a binding agent would have a basis weight between 0.0165 to 0.0350 pounds per square foot, preferably 0.0200 pounds per square foot. The mat would have machine direction tensile strength between 40 to 90 pounds per inch, preferably 70 pounds per inch. The mat web would contain enough porosity to enable the embedding process into the core mix.

All of the compositions and/or methods and/or processes and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or apparatus and/or processes and in the steps or in the sequence of steps of the methods described herein without departing from the concept, spirit and scope of the invention. All such similar substitutes and modifications apparent to those skilled in the art are deemed to be within the spirit, scope and concept of the invention.

What is claimed is:

1. A cementitious panel having two opposed major surfaces and including a core comprising a material selected from the group consisting of gypsum, portland cement, and a mixture thereof, at least one of the major surfaces having a reinforcing web embedded therein, the reinforcing web comprising basalt fibers in a form selected from the group consisting of a mesh, mat and fabric.

2. The cementitious panel of claim 1, wherein the reinforcing web is embedded in both opposed major surfaces.

3. The cementitious panel of claim 2, wherein the reinforcing web consists essentially of basalt fibers.

4. The cementitious panel of claim 1, wherein the basalt fiber reinforcement web is in the form of a mesh embedded in both major surfaces, the mesh comprising a plurality of longitudinal basalt fiber strands in spaced, parallel relationship and a plurality of transverse basalt fiber strands in spaced, parallel relationship, the transverse basalt fiber strands disposed perpendicularly to, and in contact with, the longitudinal basalt fiber strands.

5. The cementitious panel of claim 4, wherein the longitudinal strands and the transverse strands are secured together where the longitudinal strands and the transverse strands are in contact.

6. The cementitious panel of claim 5, wherein the longitudinal strands and the transverse strands each comprise a plurality of 400 to 1,200 basalt fiber filaments.

7. The cementitious panel of claim 4, wherein the mesh comprises longitudinal rovings and transverse rovings, each roving comprising a bundle of 8 to 35 basalt fiber strands.

8. The cementitious panel of claim 1, wherein the reinforcing web comprises a woven fabric comprising basalt fibers in both the warp and fill directions, wherein the warp and fill fibers are spaced sufficiently to allow the unset core material to penetrate the fabric to embed the fabric in a surface of the core material.

9. The cementitious panel of claim 1, wherein the reinforcing web comprises a non-woven mat produced by water-laying or air-laying basalt fibers.

10. The cementitious panel of claim 9, wherein the fibers are adhered together with a binder for the basalt fibers.

11. The cementitious panel of claim 1, wherein the core comprises a mixture of calcium sulfate hemihydrate, portland cement, and silica fume.

12. The cementitious panel of claim 1, wherein the core comprises gypsum.

13. The cementitious panel of claim 1, wherein the core further comprises about 0.5% to about 2% by weight expanded polystyrene beads homogeneously dispersed therein.

14. The cementitious panel of claim 11, wherein the core comprises:
calcium sulfate hemihydrate;
a cement component selected from the group consisting of portland cement; and a blend of portland cement and aggregate; and
a third component selected from the group consisting of silica fume and rice-husk ash, the third component, comprising up to about 0.6 weight percent Al₂O₃, and being at least about 92 weight percent amorphous SiO₂.

15. The cementitious panel of claim 14, prepared by dry-blending the calcium sulfate hemihydrate, the cement component, and the third component and wherein a ratio of the third component to the cement component is at least about 0.3/1.0.

16. The cementitious panel of claim 14, prepared by dry-blending the calcium sulfate hemihydrate and the cement component, followed by mixing with water into which the third component has been pre-dispersed, and wherein the ratio of the third component to the cement component is at least about 0.2/1.0.

17. The cementitious panel of claim 14, comprising about 20 weight percent to about 75 weight percent calcium sulfate hemihydrate, about 10 weight percent to about 60 weight percent of the cement component, and about 4 weight percent to about 20 weight percent of the third component.

18. The cementitious panel of claim 17, comprising about 60 weight percent to about 75 weight percent calcium sulfate hemihydrate, about 20 weight percent to about 31 weight percent of the cement component, and about 6 weight percent to about 9 weight percent of the third component.

19. The cementitious panel of claim 17, comprising about 60 weight percent to about 75 weight percent calcium sulfate hemihydrate, about 21 weight percent to about 33 weight percent of the cement component, and about 4 weight percent to about 7 weight percent of the third component.

20. The cementitious panel of claim 17, comprising about 50 weight percent to about 60 weight percent calcium sulfate hemihydrate, about 31 weight percent to about 37 weight percent of the cement component, and about 9 weight percent to about 11 weight percent of the third component.

21. The cementitious panel of claim 17, comprising about 50 weight percent to about 60 weight percent calcium sulfate hemihydrate, about 33 weight percent to about 42 weight percent of the cement component, and about 7 weight percent to about 8 weight percent of the third component.

22. The cementitious panel of claim 17, comprising about 40 weight percent to about 50 weight percent calcium sulfate hemihydrate, about 39 weight percent to about 46 weight percent of the cement component, and about 12 weight percent to about 14 weight percent of the third component.

23. The cementitious panel of claim 17, for use in exterior applications comprising about 40 weight percent to about 50 weight percent calcium sulfate hemihydrate, about 42 weight percent to about 50 weight percent of the cement component, and about 9 weight percent to about 10 weight percent of the third component.

24. The cementitious panel of claim 1, wherein the calcium sulfate hemihydrate is calcium sulfate beta-hemihydrate.

25. The cementitious panel of claim 1, wherein the cement component is Type III portland cement.

26. The cementitious panel of claim 1, wherein the third component is silica fume produced from the Silicon Metal Process.

27. The cementitious panel of claim 1, wherein the reinforcing web is a mesh having 7 to 12 ends per inch in the warp direction and 6 to 9 ends in the fill direction.

28. The cementitious panel of claim 1, wherein the mesh has an initial tensile strength of at least about 75 pounds in the warp direction and at least about 60 pounds in the fill direction.

29. The cementitious panel of claim 28, wherein the mesh has an initial tensile strength of about 75 to about 125 pounds in the warp direction and about 60 to 90 pounds in the fill direction.

30. The cementitious panel of claim 9, wherein the non-woven mat is found from randomly laid chopped basalt fiber strands having a diameter in the range of about 8 mm to about 12 mm, the strands adhered together with a binder.

31. The cementitious panel of claim 30, wherein the mat has a basis weight in the range of about 0.0165 to about 0.0350 pounds per square foot.

32. The cementitious panel of claim 31, wherein the mat has a tensile strength in the machine direction in the range of about 40 to about 90 pounds per square inch.

33. The cementitious panel of claim 1, wherein the core comprises:
about 0 weight percent to about 90 weight percent of a filler component selected from the group consisting of aggregates and fibers; and
about 10 weight percent to 100 weight percent of a binder comprising:
calcium sulfate hemihydrate;
a cement component selected from the group consisting of portland cement; and a blend of portland cement and an aggregate; and
a third component selected from the group consisting of silica fume and rice-husk ash, the third component having a particle average diameter between about 0.1 and about 0.3 microns, comprising up to about 0.6 weight percent Al₂O₃, and being at least 92 weight percent amorphous SiO₂.

34. The cementitious panel of claim 33, wherein the filler component is a cellulosic fiber.

35. The cementitious panel of claim 33, wherein the filler component is selected from the group consisting of wood fiber, plant fiber, paper, and mixtures thereof.

36. The cementitious panel of claim 33, wherein the filler component is a cellulosic fiber, the fiber being between about 10 weight percent and about 30 weight percent of the cementitious composition.

37. The cementitious panel of claim 33, wherein the filler component is a pozzolanic aggregate.

38. The cementitious panel of claim 37, wherein the pozzolanic aggregate is between about 10 weight percent and about 50 weight percent of the cementitious composition.

39. The cementitious panel of claim 38, wherein the pozzolanic aggregate is selected from the group consisting of hollow silicate spheres, pearlite, pumice, trass, diatomaceous earth, and mixtures thereof.
